(19) United States
(12) Patent Application Publication
(10) Pub. No.: US 2024/0140822 A1
(43) Pub. Date: May 2, 2024

(54) WATER PURIFIER AND METHOD FOR ASSEMBLING THE SAME

(71) Applicant: COWAY Co., Ltd., Gongju-si (KR)

(72) Inventors: Eui Hwan LEE, Gongju-si (KR); Chan Jung PARK, Gongju-si (KR); Jun HER, Gongju-si (KR); Myeong Hoon KANG, Gongju-si (KR); Gyeong Cheol SIN, Gongju-si (KR); Sang Gu SIM, Gongju-si (KR)

(73) Assignee: COWAY Co., Ltd., Gongju-si (KR)

(21) Appl. No.: 18/495,824

(22) Filed: Oct. 27, 2023

(30) Foreign Application Priority Data
Nov. 1, 2022 (KR) 10-2022-0144071

(51) Int. Cl. C02F 1/00

(52) U.S. Cl. CPC C02F 1/001; C02F 2201/007

(57) ABSTRACT

A water purifier is provided. A water purifier according to one aspect of the present invention may include a housing having a first accommodation space therein, and made of a paper material; a water purifier faucet disposed in the first accommodation space to receive raw water and discharge purified water; and a filter coupled to the water purifier faucet to generate the purified water by filtering the raw water, wherein the water purifier faucet includes a base frame having a second accommodation space therein in which the filter is accommodated; a water inlet module provided on one side of the base frame to supply raw water introduced from the outside to the filter; and a water outlet module provided on the other side of the base frame to receive the purified water generated by the filter and discharge it to the outside.

### CROSS-REFERENCE TO RELATED APPLICATION

This application claims priority to and the benefit of Korean Patent Application No. 10-2022-0144071, filed on Nov. 1, 2022, the disclosure of which is incorporated herein by reference in its entirety.

### TECHNICAL FIELD

The present invention relates to a water purifier and a method for assembling the same, and more particularly, to a water purifier having a housing made of paper and a method for assembling the same.

### BACKGROUND

A water purifier is an apparatus that filters inflow water (raw water) with a filter to generate purified water and provide it to users. In general, a water purifier includes a filter unit including at least one filter to filter water, and an extraction unit including a cock or faucet to provide purified water filtered by the filter unit to users.

Water supplied to the filter unit is supplied to the inside of the water purifier through an external water inlet pipe, and water generated inside the filter unit or water purifier is drained to the outside through an external drain pipe (drain pipe).

US Patent Laid-Open Publication No. 2021-0316251 of COWAY Co., Ltd. discloses a conventional water purifier. Such a water purifier includes a water purifier body individually assembled, a filter bracket installed in the water purifier body, a plurality of filters coupled to the filter bracket, and a pump unit that introduces raw water into the filter, and is configured to provide purified water by filtering raw water supplied from the outside.

However, since such a water purifier is composed of many components and the coupling and arrangement relationships between the components are complicated, assembly and disassembly processes are difficult, which may increase manufacturing costs, maintenance and repair costs.

In addition, since such a water purifier cannot be directly assembled or disassembled by customers without knowledge of coupling and arrangement relationships, it is difficult to maintain and repair the water purifiers in areas or situations where it is difficult for our staff to visit.

Korean Patent Laid-Open Publication No. 2022-0096521 of COWAY Co., Ltd. discloses a conventional water purifier. Such a water purifier includes a flow path module through which raw water is introduced from the outside into the housing (main frame) or purified water is discharged to the outside; a filter module generating purified water by filtering raw water; and a valve module for controlling a flow path.

However, since most components such as housings of these water purifiers are made of plastics or metals that are difficult to recycle and do not decompose in a natural state, and a large amount of waste may be generated during the manufacturing and production process as well as the disposal process after use, there is a problem that may cause environmental pollution and waste of resources.

Korean Patent Laid-Open Publication No. 2022-0132321 of COWAY Co., Ltd. discloses a conventional water purifier. Such a water purifier includes a water inlet unit through which raw water is introduced into the housing; a filter unit filtering the introduced raw water to generate purified water, a water outlet unit that discharges the generated purified water, an operation element for implementing a predetermined function, and a power supply unit and a power source for supplying power to the operation element.

However, since such a water purifier needs to be supplied with power, that is, energy from the outside, in places or situations where there is no access to power, such as outdoor areas such as campgrounds, places with insufficient social infrastructure such as developing countries, and emergency situations such as power outages, there is a problem that even the basic function of filtering raw water to produce purified water cannot be provided.

In addition, such a water purifier lacks portability and ease of installation, as most of the components, such as the housing, are made of plastic or metal, making the water purifier heavy, and are configured to be used in a fixed location by connecting to power and water piping, etc.

### RELATED ART DOCUMENT

### Patent Document

(Patent Document 1) US Patent Laid-Open Publication No. 2021-0316251
(Patent Document 2) Korean Patent Laid-Open Publication No. 2022-0096521
(Patent Document 3) Korean Patent Laid-Open Publication No. 2022-0132321

### SUMMARY OF THE INVENTION

### Technical Problem

The present invention has been devised in view of the above problems, and is directed to providing a water purifier and a method for assembling the same, in which each component can be easily disassembled and reassembled without special knowledge or tools, so that there is no limitation in portability and usability due to space limitations, and maintenance is easy.

The present invention is also directed to providing a water purifier and a method for assembling the same that can be disassembled and then reassembled into a box structure having a single shape, thereby improving user convenience, storage ease and portability.

The present invention is also directed to providing a water purifier a method for assembling the same that does not require a separate power source or energy to filter raw water to generate purified water, and thus can be used in places or situations where a power source is not available, such as outdoor areas such as campgrounds, places without sufficient social infrastructure facilities such as developing countries, and emergency situations such as power outages.

The present invention is also directed to providing a water purifier a method for assembling the same in which the housing accommodating and protecting the other components is made of a paper material that can be easily disassembled, so that when it is discarded after assembly or use, it does not cause environmental pollution or waste of resources by waste.

The present invention is also directed to providing a water purifier a method for assembling the same that can prevent environmental pollution or waste of resources due to waste, as packaging members used for packaging can be recycled as one component of the water purifier, thereby minimizing waste.

The present invention is also directed to providing a water purifier a method for assembling the same that has improved storage ease and portability, since the water inlet module and the water outlet module, which are components for receiving raw water and outputting a generated purified water, can be disassembled into a plurality of subparts and compactly accommodated in an internal space of a base frame.

The present invention is also directed to providing a water purifier a method for assembling the same that allows the base frame or filter to enter and exit through an open one side portion of the housing, thereby facilitating maintenance and care by a user.

The present invention is also directed to providing a water purifier a method for assembling the same capable of protecting components accommodated inside the housing from the outside while achieving easy maintenance and management by including a cover part capable of opening and closing open one side portion of the housing.

The problems of the present invention are not limited to those mentioned above, and other problems not mentioned will be clearly understood by those of ordinary skill in the art from the following description.

### Technical Solution

According to one aspect of the present invention, a water purifier is provided, including a housing having a first accommodation space therein, and made of a paper material; a water purifier faucet disposed in the first accommodation space to receive raw water from the outside and discharge purified water to the outside; and a filter coupled to the water purifier faucet to generate the purified water by filtering the raw water, wherein the water purifier faucet includes a base frame having a second accommodation space therein in which the filter is accommodated; a water inlet module provided on one side of the base frame to supply raw water introduced from the outside to the filter; and a water outlet module provided on the other side of the base frame to receive the purified water generated by the filter and discharge it to the outside.

In this case, in a packaged state in which the filter, the base frame, the water inlet module, and the water outlet module are packaged, the housing may be provided to be formed by reassembling a first box structure provided to package at least one of the filter, the base frame, the water inlet module, and the water outlet module.

In this case, the housing may include an accommodation part with one side portion of which is opened so that the first accommodation space can communicate with the outside, and the base frame may have one side portion open so that the filter can enter and exit the second accommodation space through the opening of the accommodation part.

In this case, one part of the opening of the accommodation part may be open in one direction so that the water purifier faucet can enter and exit the first accommodation space.

In this case, the opening of the base frame may be opened in a different direction, and another part of the opening of the accommodation part may be opened in the different direction so that the filter may enter and exit the second accommodation space.

In this case, a water inlet module through-hole for exposing one end of the water inlet module to the outside of the housing for receiving raw water from the outside may be provided on one surface of the accommodation part, and the water inlet module through-hole may extend along the one direction.

In this case, the housing may include a flat plate-shaped cover part provided on one side of the accommodation part to close the opening of the accommodation part in a closed position and open the opening of the accommodation part to the outside in an open position.

In this case, the other side portion of the cover part may be connected to the accommodation part so that the one side portion can be rotated with respect to the accommodation part.

In this case, in a packaged state in which the filter, the base frame, the water inlet module, and the water outlet module are packaged, the housing may be provided to be formed by reassembling a first box structure provided to package at least one of the filter, the base frame, the water inlet module, and the water outlet module, the first box structure may be provided to be formed by assembling a first box structure assembling cardboard, and the first box structure assembling cardboard may include a plurality of flat plates that are foldably connected to form one side surface of the accommodation part, the other side surface opposite to the one side surface and provided with the other part of the opening of the accommodation part, a front surface, a rear surface, and a bottom surface; a top surface cover plate that is foldably connected to any one of the plurality of plates to open and close the one part of the opening of the accommodation part provided between the one side surface and the other side surface of the accommodation part; and a side surface cover plate that is foldably connected to one side of the top surface cover plate to open and close the other part of the opening of the accommodation part.

In this case, a fixing protrusion may be provided on the one side portion of the cover part, and a fixing protrusion insertion part into which the fixing protrusion can be inserted may be provided in the accommodation part when the cover part is positioned in the closed position.

In this case, the water outlet module may include a water outlet unit protruding outward from the base frame and having a water outlet hole for discharging purified water on one side portion; and an operation unit provided on the other side portion of the water outlet unit to operate the water outlet unit.

In this case, the housing may include an accommodation part for accommodating the base frame; and a water outlet unit cover part provided at one side of the accommodation part to cover the water outlet unit of the water outlet module, and having a water outlet hole for exposing the water outlet hole to the outside and an operation unit through-hole through which the operation unit passes.

In this case, the water outlet unit may protrude forward of the base frame; in a packaged state in which the filter, the base frame, the water inlet module, and the water outlet module are packaged, the housing may be provided to be formed by reassembling a first box structure provided to package at least one of the filter, the base frame, the water inlet module, and the water outlet module; the first box structure may be provided to be formed by assembling a first box structure assembling cardboard; and the first box structure assembling cardboard may include a plurality of flat plates that are foldably connected to form one side surface of the accommodation part, the other side surface opposite to the one side surface, and a bottom surface; a first rear surface plate that is foldably connected to one of the plurality of flat plates to form a rear surface of the accommodation part; a first front surface plate that is foldably connected to one of the plurality of flat plates to form a front surface of the accommodation part; a water outlet unit bottom surface plate that is foldably connected to one side of the first front surface plate to cover a lower portion of the water outlet unit, and having the water outlet hole; a water outlet unit front surface plate that is foldably connected to one side portion of the water outlet unit bottom surface plate to cover a front portion of the water outlet unit; and a water outlet unit top surface plate that is foldably connected to one side portion of the water outlet unit front surface plate to cover an upper portion of the water outlet unit, and having the operation unit through-hole.

In this case, the first front surface plate may have a vertical length shorter than that of the first rear surface plate.

In this case, the vertical length of the water outlet unit front surface plate may correspond to a difference between the vertical lengths of the first rear surface plate and the first front surface plate.

In this case, the water purifier may further include a reinforcing frame made of paper and interposed between a portion of an inner surface of the housing and a portion of an outer surface of the water purifier faucet so that the water purifier faucet can be fixed to the first accommodation space.

In this case, the reinforcing frame may include a reinforcing part covering a portion of an outer surface of the water purifier faucet; a bent part bent from one side portion of the reinforcing part toward the outside of the reinforcing part; and an extension part extending from the bent part, one surface of which is disposed to face an outer surface of the reinforcing part.

In this case, a water inlet module through-hole for exposing one end of the water inlet module to the outside for receiving raw water from the outside may be provided on one surface of the reinforcing part.

In this case, in a packaged state in which the filter, the base frame, the water inlet module, and the water outlet module are packaged, the housing may be provided to be formed by reassembling a first box structure provided to package at least one of the filter, the base frame, the water inlet module, and the water outlet module, and in the packaged state, the reinforcing frame may be provided to be formed by reassembling a second box structure provided to package at least one of the filter, the base frame, the water inlet module, and the water outlet module.

In this case, the second box structure may be provided to be formed by assembling a second box structure assembling cardboard; and the second box structure assembling cardboard may include a plurality of flat plates that are foldably connected to form one side surface, a rear surface, and a bottom surface of the reinforcing part; and a second front surface plate formed to be foldable on one of the plurality of flat plates and having a cutting line in a horizontal direction so that the second front surface plate can be separated into a second lower front surface plate capable of forming the front surface of the reinforcing part and a second upper front surface plate capable of forming the extension part.

In this case, the water purifier may further include a support plate having a plate shape and having a fixing groove formed on one surface so that one side portion of the housing can be inserted and fixed.

In this case, in a packaged state in which the filter, the base frame, the water inlet module, and the water outlet module are packaged, the housing may be provided to be formed by reassembling a first box structure provided to package at least one of the filter, the base frame, the water inlet module, and the water outlet module; and the support plate may be a packaging buffer member for packaging into which one side portion of the first box structure can be inserted into the fixing groove so that the support plate can cover one side portion of the first box structure in the packed state to protect the first box structure from external impact.

In this case, the support plate may be made of a honeycomb material made of paper.

In this case, the water purifier may further include a cup holder having a support hole into which a cup can be inserted and supported; the one side portion of the housing may be inserted into a part of the fixing groove; and the cup holder may be inserted into the other part of the fixing groove.

In this case, the cup holder may be provided to be formed by reassembling a part of a second box structure accommodated in the first box structure in the packaged state, and the second box structure may be provided to package at least one of the filter, the base frame, the water inlet module and the water outlet module.

In this case, the water purifier faucet may be formed by assembling a water purifier faucet assembly kit, the water purifier faucet assembly kit including a plurality of water inlet flow passage forming members that can be coupled to each other; a pressure reducing member that can be provided between the water inlet flow passage forming members; a water outlet member forming a flow passage through which the purified water is discharged to the outside; an operation member coupled to one side portion of the water outlet member to operate the water outlet member; and the base frame for supporting the plurality of water inlet flow passage forming members and the water outlet member.

In this case, the second accommodation space of the base frame may accommodate the plurality of water inlet flow passage forming members, the pressure reducing member, the water outlet member and the operation member.

In this case, the water purifier may further include a raw water tank capable of accommodating raw water to be supplied to the water inlet module; and a raw water supply pipe forming a flow passage so that raw water can be supplied from the raw water tank to the water inlet module.

In this case, a waterproof layer having a waterproof function may be provided on at least a part of the inner surface of the housing.

According to another aspect of the present invention, a method for assembling a water purifier is provided, including: preparing a water purifier box package in which a water purifier filter, a water purifier base frame, a water purifier water inlet module, and a water purifier water outlet module are packaged therein, the water purifier box package comprising a first box structure in which at least one of the filter, the base frame, the water inlet module, and the water outlet module is packaged; taking out the filter, the base frame, the water inlet module, and the water outlet module from the water purifier box package; forming a water purifier faucet by assembling the filter, the base frame, the water inlet module, and the water outlet module; forming a housing having a first accommodation space therein by reassembling the first box structure; and forming a water purifier body by disposing the water purifier faucet in the first accommodation space.

In this case, the water purifier box package may include a second box structure in which at least one of the water inlet module and the water outlet module is packaged; the method may further include forming a reinforcing frame interposed between a portion of an outer surface of the water purifier faucet and a portion of an inner surface of the housing by reassembling at least a portion of the second box structure; and forming an intermediate assembly by assembling the reinforcing frame and the water purifier faucet such that the reinforcing frame covers the portion of an outer surface of the water purifier faucet; and in the forming the water purifier body, the intermediate assembly may be disposed in the first accommodation space.

In this case, the water purifier box package may include a second box structure in which at least one of the water inlet module and the water outlet module is packaged; and the method may further include forming a cup holder having a support hole into which a cup can be inserted by reassembling at least a portion of the second box structure; and disposing the cup holder on one side of the water purifier body.

In this case, the water purifier box package may further include a packaging buffer member having a fixing groove into which the one side portion of the first box structure is inserted and fixed so that the first box structure can be protected from external impact, and the method may further include inserting and fixing one side portion of the water purifier body into the fixing groove.

In this case, the first box structure may be made of a paper material.

### Advantageous Effects

Since each component of the water purifier and the method for assembling the same according to an embodiment of the present invention can be easily disassembled and reassembled without special knowledge or tools, there is no limit to portability and usability due to space limitations, and maintenance is easy.

In addition, since the water purifier and the method for assembling the same according to an embodiment of the present invention can be reassembled in a box-shaped package, user convenience, storage ease and portability can be improved.

In addition, the water purifier according to an embodiment of the present invention does not require a separate power source or energy to filter raw water to generate purified water, and thus can be used in places or situations where a power source is not available, such as outdoor areas such as campgrounds, places without sufficient social infrastructure facilities such as developing countries, and emergency situations such as power outages.

In addition, the water purifier and the method for assembling the same according to an embodiment of the present invention have a housing accommodating and protecting the other components made of a paper material that can be easily disassembled, so that when it is discarded after assembly or use, it does not cause environmental pollution or waste of resources by waste.

In addition, the water purifier and the method for assembling the same according to an embodiment of the present invention can prevent environmental pollution or waste of resources due to waste, as packaging members used for packaging can be recycled as one component of the water purifier, thereby minimizing waste.

In addition, the water purifier and the method for assembling the same according to an embodiment of the present invention have improved storage ease and portability, since the water inlet module and the water outlet module, which are components for receiving raw water and outputting a generated purified water, can be disassembled into a plurality of subparts and compactly accommodated in an internal space of a base frame.

In addition, the water purifier and the method for assembling the same according to an embodiment of the present invention allow the base frame or filter to enter and exit through an open one side portion of the housing, thereby facilitating maintenance and care by a user.

In addition, the water purifier and the method for assembling the same according to an embodiment of the present invention can protect components accommodated inside the housing from the outside while achieving easy maintenance and management by including a cover part capable of opening and closing open one side portion of the housing.

Advantageous effects of embodiments of the present invention are not limited to the above-described effects, and other effects not mentioned will be clearly understood by those of ordinary skill in the art from the present specification and the accompanying drawings.

### BRIEF DESCRIPTION OF THE DRAWINGS

FIG. 1 is a perspective view of a water purifier box package according to an exemplary embodiment of the present invention, viewed from an upper side. In this case, the outer packaging box structure is indicated by a dotted line, and components seen through it are indicated by solid lines.

FIG. 2 is an exploded perspective view of an upper packaging buffer member, a filter, a first box structure, and a lower packaging buffer member of the water purifier box package according to an exemplary embodiment of the present invention.

FIG. 3A is a plan view of a first box structure assembling cardboard according to an exemplary embodiment of the present invention.

FIG. 3B is a perspective view of a first box structure of the water purifier box package according to an exemplary embodiment of the present invention, viewed from an upper side.

FIG. 3C is a view illustrating a process of taking out a second box structure according to an exemplary embodiment of the present invention by opening a first box structure according to an exemplary embodiment of the present invention.

FIG. 4A is a plan view of a second box structure assembling cardboard according to an exemplary embodiment of the present invention.

FIG. 4B is a view illustrating a process of taking out a water purifier faucet assembly kit according to an exemplary embodiment of the present invention by opening a second box structure according to an exemplary embodiment of the present invention.

FIGS. 4C and 4D are views for explaining a process of reassembling a second box structure according to an exemplary embodiment of the present invention into a reinforcing frame and a cup holder.

FIG. 5A is a view illustrating a process of taking out a water purifier faucet assembly kit according to an exemplary embodiment of the present invention from an accommodation space of a base frame according to an exemplary embodiment of the present invention.

FIG. 5B is an exploded perspective view of a water purifier faucet according to an exemplary embodiment of the present invention, viewed from a front upper side. In this case, an operation unit of a water outlet module is not illustrated.

FIG. 5C is an exploded perspective view of a water purifier faucet according to an exemplary embodiment of the present invention, viewed from a rear upper side. In this case, an operation unit of a water outlet module is not illustrated.

FIG. 6 is a view for explaining a process of forming an intermediate assembly by coupling a water purifier faucet and a reinforcing frame according to an exemplary embodiment of the present invention.

FIGS. 7A and 7B are views for explaining a process of reassembling a first box structure according to an exemplary embodiment of the present invention into a housing and forming a water purifier body by coupling the reassembled housing and the intermediate assembly.

FIG. 8A is a view illustrating a process of forming a water purifier by coupling a water purifier body, a support plate, and a cup holder according to an exemplary embodiment of the present invention.

FIG. 8B is a perspective view of a water purifier according to an exemplary embodiment of the present invention, viewed from an upper side.

FIG. 9A is a view illustrating a process of forming a modification example of a water purifier according to an exemplary embodiment of the present invention.

FIG. 9B is a perspective view of a modification example of a water purifier according to an exemplary embodiment of the present invention, viewed from an upper side.

FIG. 10 is a flowchart for explaining a method for assembling a water purifier according to an exemplary embodiment of the present invention.

### DETAILED DESCRIPTION OF THE EMBODIMENTS

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, like reference numerals denote like elements.

Terms and words used in the present specification and claims should not be construed as limited to their usual or dictionary definition, and they should be interpreted as a meaning and concept consistent with the technical idea of the present invention based on the principle that inventors may appropriately define the terms and concept in order to describe their own invention in the best way.

It should be understood that the terms “comprise” or “have” or the like when used in this specification, are intended to describe the presence of stated features, integers, steps, operations, elements, components and/or a combination thereof but not preclude the possibility of the presence or addition of one or more other features, integers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

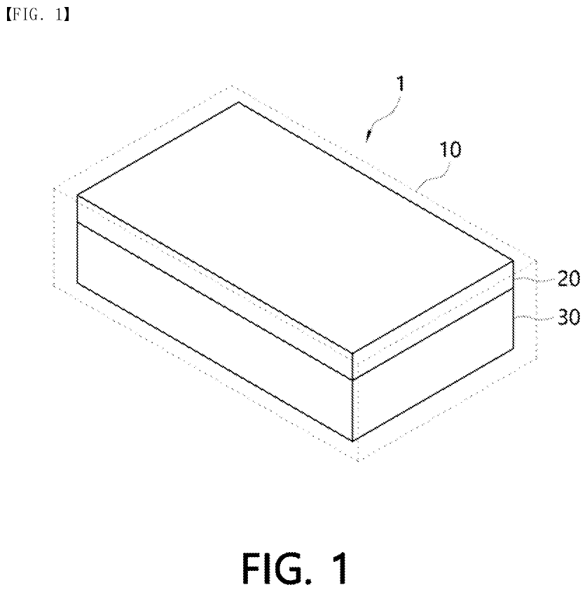

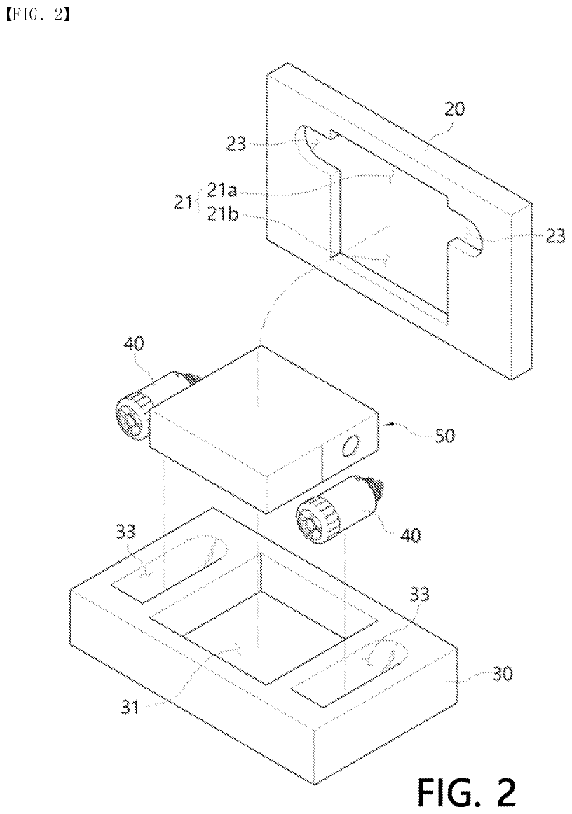

FIG. 1 is a perspective view of a water purifier box package according to an exemplary embodiment of the present invention, viewed from an upper side. In this case, the outer packaging box structure is indicated by a dotted line, and components seen through it are indicated by solid lines. FIG. 2 is an exploded perspective view of an upper packaging buffer member, a filter, a first box structure, and a lower packaging buffer member of the water purifier box package according to an exemplary embodiment of the present invention.

The water purifier according to an embodiment of the present invention relates to a water purifier whose housing is made of paper, which is environmentally friendly and easily degradable in nature, thereby preventing environmental pollution due to waste and waste of resources and increasing portability and convenience of use.

In this case, the water purifier according to an embodiment of the present invention may be formed by (re)assembling a water purifier box package and components packaged by the water purifier box package according to an embodiment of the present invention, which will be described later, and hereinafter, a water purifier box package and components packaged by the water purifier box package according to an embodiment of the present invention will be described first.

The water purifier box package according to an embodiment of the present invention relates to a box package capable of forming a water purifier by (re)assembling components packed therein and at least a part of the water purifier box package without specialized knowledge or special tools.

Hereinafter, a state in which a water purifier box package and components packaged thereby according to an embodiment of the present invention are not assembled into a water purifier is referred to as a packaged state, and a state in which a water purifier is assembled and formed is referred to as a water purifier assembled state.

Unless otherwise mentioned, in the present disclosure, it will be described assuming that the water purifier box package and the components packaged thereby are placed in a packaged state in which the water purifier box package is packaged in a single box shape for ease of storage, portability, or delivery.

In this case, in the present disclosure, a water purifier box package may refer to a structure in which a plurality of box structures and a plurality of buffer members are assembled or coupled in a predetermined manner to package a filter and a water purifier faucet assembly kit to be described later to be housed and protected therein.

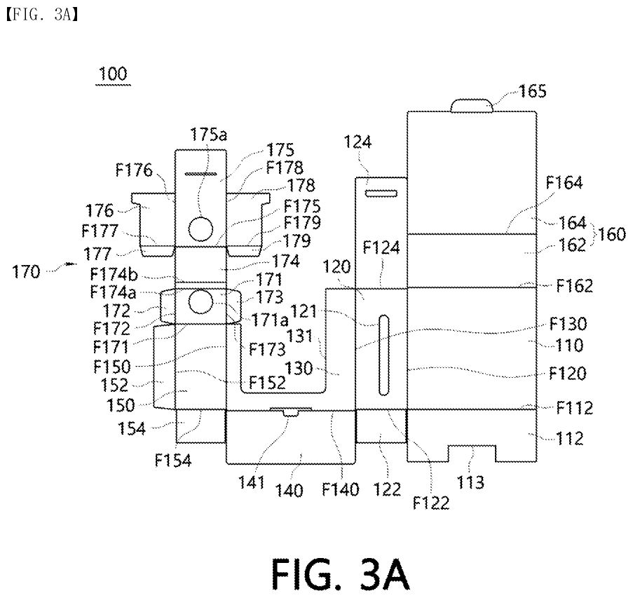

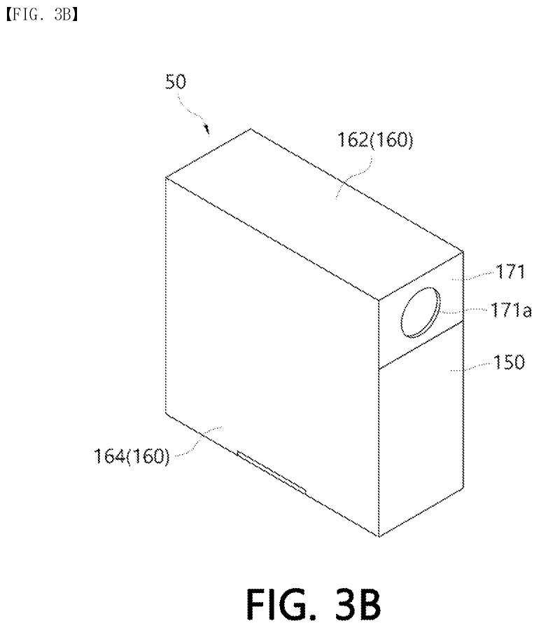

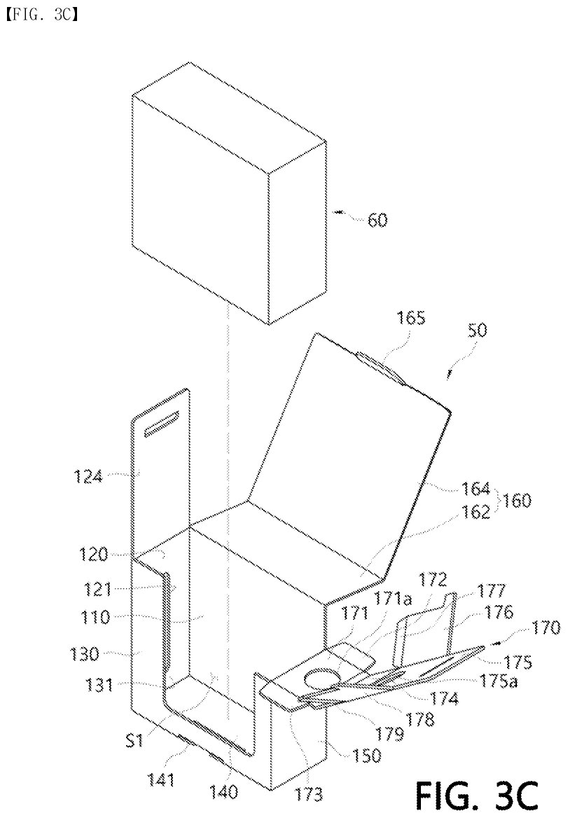

Referring to FIGS. 1 and 2, a water purifier box package 1 according to an embodiment of the present invention may include an outer packaging box structure 10, an upper packaging buffer member 20, a lower packaging buffer member 30, a first box structure 50, and a second box structure 60 (shown in FIG. 3C).

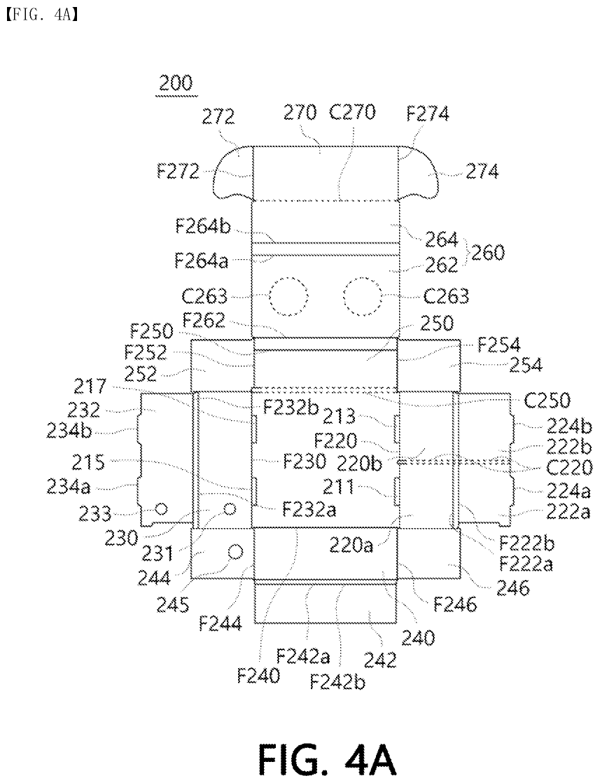

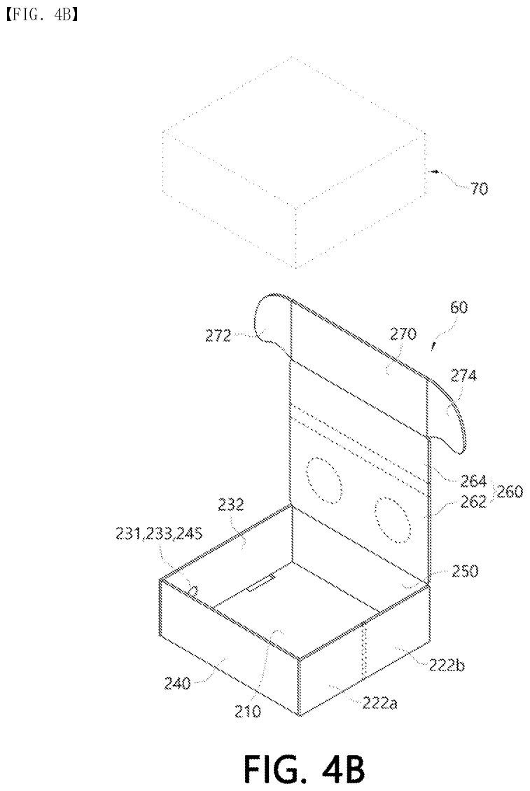

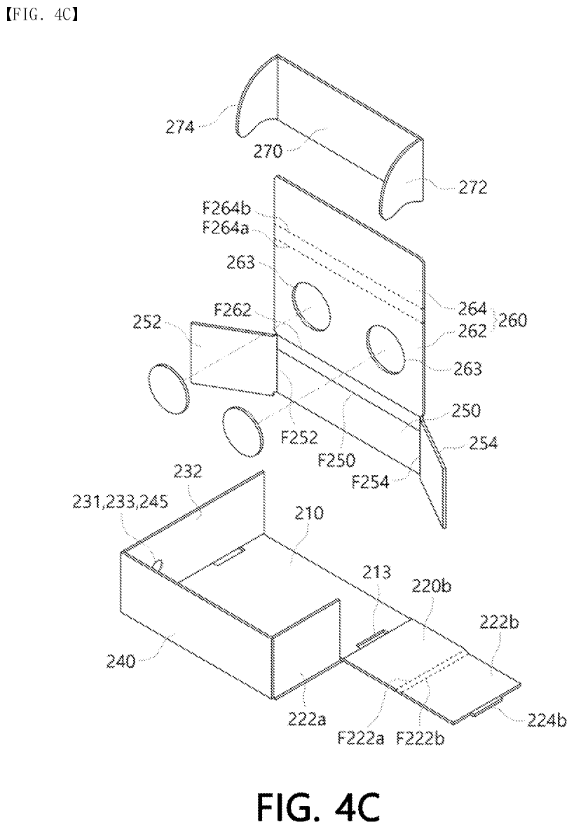

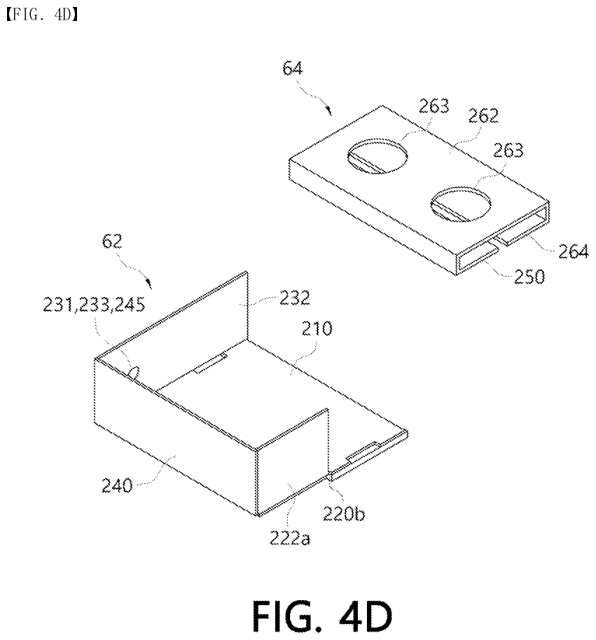

In this case, in the present embodiment, a water purifier faucet assembly kit 70 (shown in FIG. 4B) to be described below may be packaged by the first box structure 50 and the second box structure 60 (shown in FIG. 3C). In addition, a filter 40 may be packaged by the upper and lower packaging buffer members 20 and 30.

However, it is not limited thereto, and it will be also possible that the filter 40 may be configured to be accommodated in the first box structure 50 and the second box structure 60, or one component of the water purifier faucet assembly kit 70 (shown in FIG. 4B) may be configured to be packaged in the upper and lower packaging buffer members 20 and 30.

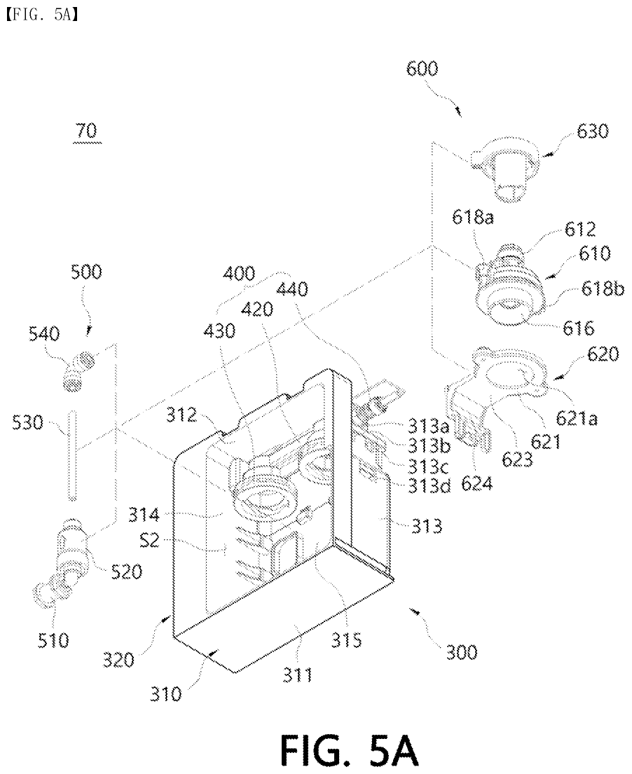

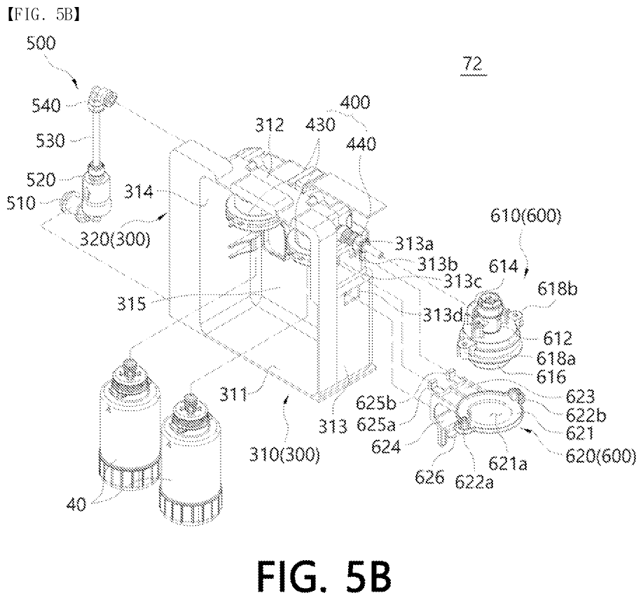

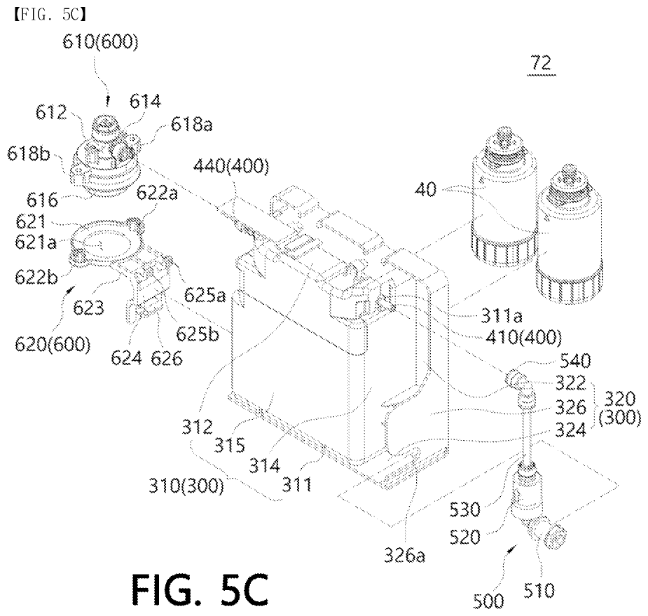

As will be described later in detail, the second box structure 60 (shown in FIG. 3C) may be accommodated in the first box structure 50, and the water purifier faucet assembly kit 70 (shown in FIG. 4B) may be accommodated in the second box structure 60 (shown in FIG. 3C). The water purifier faucet assembly kit 70 (shown in FIG. 4B) may be assembled into a water purifier faucet 72 (shown in FIG. 5B).

In this case, the water purifier faucet 72 (shown in FIG. 5B) is an assembly for providing a basic function of a water purifier that filter raw water together with the filter 40 to discharge purified water, and the water purifier faucet assembly kit 70 (shown in FIG. 5A) may refer to a set of components for performing the above-described function.

Meanwhile, referring to FIG. 1, the outer packaging box structure 10 may accommodate the water purifier box package 1 according to the present embodiment and other components packaged thereby, thereby protecting them from external contamination, physical or chemical impact, and the like.

In the present embodiment, the outer packaging box structure 10 has a rectangular parallelepiped shape, but it may be variously modified as needed. As the outer packaging box structure 10, various known packaging, transporting, or storage boxes may be applied.

The upper and lower packaging buffer members 20 and 30 may be accommodated in the outer packaging box structure 10. The upper and lower packaging buffer members 20 and 30 are configured to protect the filter 40 and the first box structure 50 from external impact.

To this end, it is preferable that the upper and lower packaging buffer members 20 and 30 are made of a material capable of absorbing impact well. For example, the upper and lower packaging buffer members 20 and 30 may be made of a honeycomb board.

Honeycomb board is made by attaching plywood, asbestos cement board, etc. to both sides of a honeycomb-shaped core material made of paper or aluminum or the like, and it is light and has excellent insulation properties and strength, and thus, it can faithfully perform a function of absorbing external impact.

In this case, in the present embodiment, the upper and lower packaging buffer members 20 and 30 made of honeycomb boards may be made of paper. Accordingly, even if the upper and lower packaging buffer members 20 and 30 are easily decomposed in nature even if they are discarded after assembly or use, and thus environmental pollution caused by waste may be prevented.

The lower packaging buffer member 30 may be formed in a hexahedral shape having a sufficient volume to accommodate a predetermined object therein. The upper packaging buffer member 20 may have a plate shape having a predetermined thickness to cover one surface of the lower packaging buffer member 30.

A lower fixing groove 31 may be formed on one surface of the lower packaging buffer member 30, for example, on a central portion of the top surface as shown in FIG. 2. The lower fixing groove 31 may be formed to correspond to the shape of the first box structure 50 so that the first box structure 50 to be described later may be inserted and fixed.

Accordingly, the first box structure 50 may be inserted and fixed to the lower fixing groove 31 while being laid down in the horizontal direction. In this case, one side portion of the first box structure 50 inserted into the lower fixing groove 31 may slightly protrude onto one surface of the lower packaging buffer member 30.

A filter fixing groove 33 may be formed at both sides of the lower fixing groove 31 on one surface of the lower packaging buffer member 30. The filter fixing groove 33 is a component in which the filter 40 is inserted and fixed, and in the present embodiment, the filter 40 may be made of various known filters.

The number of filter fixing grooves 33 may be provided to correspond to the number of filters 40 described later. In the present embodiment, the number of filters 40 is illustrated as two, but the number of filters 40 is not particularly limited, and one or more filters 40 may be provided. Further, in some cases, the filter 40 may be provided separately without being packaged by the water purifier box package 1 according to the present embodiment.

The upper packaging buffer member 20 may be disposed on one side of the lower packaging buffer member 30, that is, on the upper side in the illustrated embodiment. The upper packaging buffer member 20 may cover the first box structure 50 and the filter 40 inserted and fixed to one surface of the lower packaging buffer member 30 so as not to be exposed to the outside, and may perform a function of protecting them from external impact.

To this end, an upper fixing groove 21 may be formed on one surface of the upper packaging buffer member 20 facing the lower packaging buffer member 30, for example, on a central portion of the lower surface as shown in FIG. 2.

The upper fixing groove 21 is configured to insert and fix one side portion of the first box structure 50 protruding slightly onto one surface of the lower packaging buffer member 30. To this end, the upper fixing groove 21 may also have a shape corresponding to a cross-sectional shape of the first box structure 50.

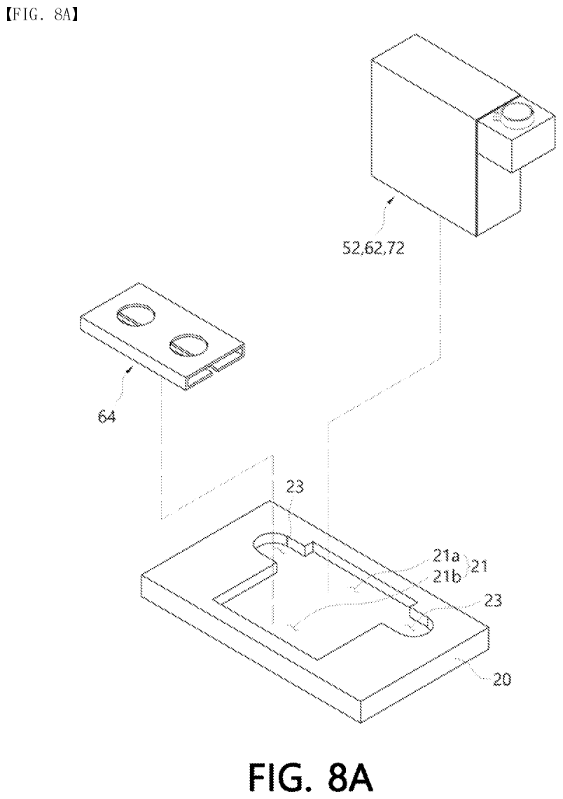

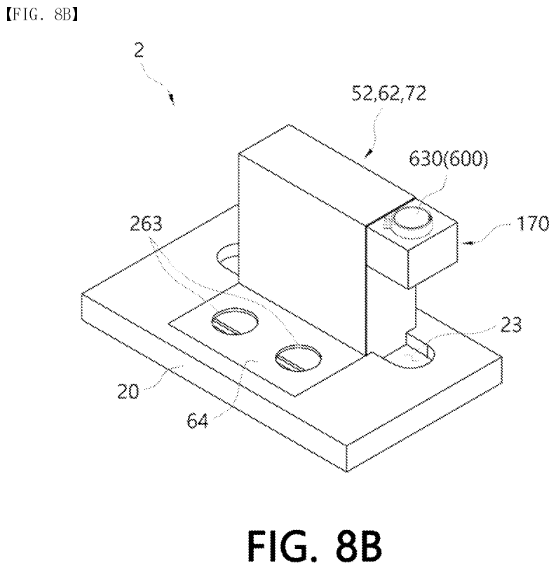

In this case, the upper fixing groove 21 may include a water purifier body fixing part 21a and a cup holder fixing part 21b. In the present embodiment, the upper packaging buffer member 20 may be used as a component of a water purifier and may be assembled together with a water purifier body 52, 62, 72 (shown in FIG. 8A) and a cup holder 64 (shown in FIG. 8A), which will be described later, to form a water purifier.

The water purifier body fixing part 21a is configured to insert and fix one side of the water purifier body 52, 62, 72 (shown in FIG. 8A), and the cup holder fixing part 21b is configured to insert and fix the cup holder 64 (shown in FIG. 8A), which will be described later together with FIG. 8A.

Meanwhile, on one surface of the upper packaging buffer member 20, a cup holding groove 23 may be provided on the side of the upper fixing groove 21. As shown in FIG. 2, the cup holding groove 23 may extend along one surface of the upper packaging buffer member 20. In this case, the end side of the cup holding groove 23 in the extension direction may be formed to be rounded.

Meanwhile, in the illustrated embodiment, the cup holding groove 23 is symmetrically formed on both sides of the upper fixing groove 21, but the shape or number thereof is not particularly limited. The cup holding groove 23 may be used as a part for placing a cup for receiving purified water discharged from the water purifier body 52, 62, 72 (shown in FIG. 8A) to be described later.

As described above, according to the water purifier box package 1 according to an embodiment of the present invention, since all components for forming a water purifier can be packaged in a single box-shaped structure, it is suitable for storage, carrying, and shipping, and through this, users can assemble and use the water purifier as needed in various places and situations.

Hereinafter, the first box structure according to an embodiment of the present invention will be described in detail.

FIG. 3A is a plan view of a first box structure assembling cardboard according to an exemplary embodiment of the present invention. FIG. 3B is a perspective view of a first box structure of the water purifier box package according to an exemplary embodiment of the present invention, viewed from an upper side. FIG. 3C is a view illustrating a process of taking out a second box structure according to an exemplary embodiment of the present invention by opening a first box structure according to an exemplary embodiment of the present invention.

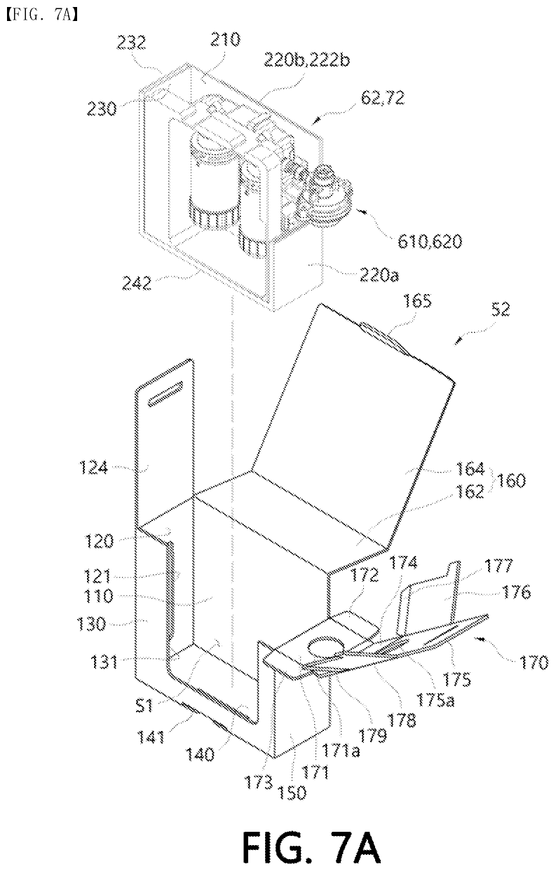

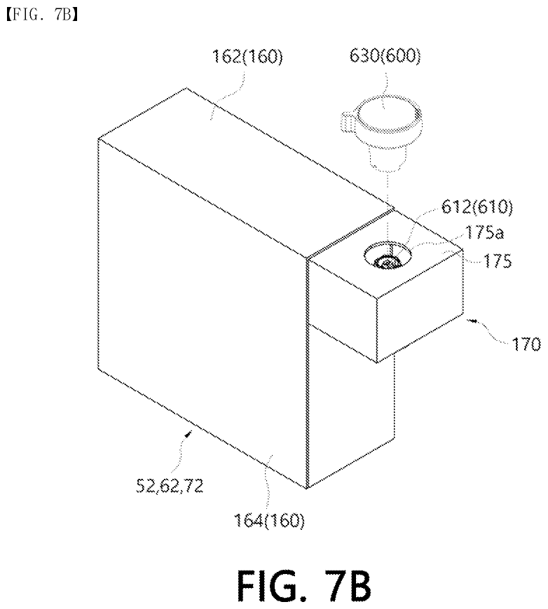

Referring to FIGS. 3A to 3C, as described above, the first box structure 50 according to the present embodiment is configured to accommodate and protect the second box structure 60 in the packaged state. In addition, as will be described later, the first box structure 50 can be reassembled into the housing 52 (shown in FIG. 7A) in the water purifier assembled state and function as a component of the water purifier.

In the present embodiment, the first box structure 50 may be formed by assembling a first box structure assembling cardboard 100. In the present embodiment, as shown in FIG. 3A, the first box structure 50 may be manufactured by bending each part of the first box structure assembling cardboard 100 along a folding line to be described later.

In the present disclosure, the folding line means a groove formed along a predetermined direction between one part and another part of the first box structure assembling cardboard 100. One part of the first box structure assembling cardboard 100 can be easily bent at a predetermined angle with the other part by the folding line. The process of forming the above-described cutting and folding lines may be performed by a punching process of punching a predetermined cardboard, or the like.

In this case, the first box structure assembling cardboard 100 may be a flat plate made of paper. For example, the first box structure 50 may be manufactured by forming cut and groove through a punching process of hard cardboard or corrugated cardboard. Accordingly, according to the present embodiment, even if the first box structure 50 is discarded after use, it can be easily decomposed in nature, and thus environmental pollution due to waste can be prevented.

Referring to FIGS. 3A and 3B, the first box structure assembling cardboard 100 according to an embodiment of the present invention may be formed of a plurality of flat plates that are connected to be foldable to each other.

In the present embodiment, the first box structure assembling cardboard 100 may include a first-1 side surface plate 110 forming a sidewall of the first box structure 50. The first-1 side surface plate 110 may be formed of a quadrangular flat plate having a predetermined thickness.

A first bottom surface cover plate 112 may be foldably connected to one side portion, that is, a lower side portion based on FIG. 3A, of the first-1 side surface plate 110. To this end, a first bottom surface cover folding line F112 may be provided between the first-1 side surface plate 110 and the first bottom surface cover plate 112.

The first bottom surface cover plate 112 is configured to cover an outer portion of a first bottom surface plate 140 of the first box structure 50. The first bottom surface cover plate 112 may cover the first bottom surface plate 140, thereby increasing the bearing capacity of the first bottom surface plate 140 and the structural stability of the first box structure 50 (or housing 52 (shown in FIG. 7A)).

In this case, an exposed groove 113 may be formed on one side portion, that is, a lower side portion based on FIG. 3A, of the first bottom surface cover plate 112. The exposed groove 113 allows a fixing protrusion insertion part 141 to be described below to be exposed to the outside, so that a fixing protrusion 165 can be easily coupled to the fixing protrusion insertion part 141.

A first rear surface plate 120 may be foldably connected to another side portion, that is, a left side portion based on FIG. 3A, of the first-1 side surface plate 110. To this end, a first rear surface folding line F120 may be formed between the first-1 side surface plate 110 and the first rear surface plate 120.

The first rear surface plate 120 is configured to form the rear surface of the first box structure 50, and may be bent to cross the first-1 side surface plate 110 in one direction. For example, the first rear surface plate 120 may be bent vertically to the left side of the first-1 side surface plate 110, as shown in FIG. 3C.

Meanwhile, a first water inlet module through-hole 121 may be formed in the first rear surface plate 120. As will be described in detail later, the first box structure 50 is reassembled into a housing 52 (shown in FIG. 7A) and accommodates a water purifier faucet 72 (shown in FIG. 7A) therein.

The first water inlet module through-hole 121 is configured to provide a flow passage through which the water purifier faucet 72 (shown in FIG. 7A) can smoothly receive raw water from the outside. In the present embodiment, a portion of the water purifier faucet 72 (shown in FIG. 7A) is exposed to the outside through the first water inlet module through-hole 121 to receive raw water.

In this case, the first water inlet module through-hole 121 may be formed in one direction, for example, in an up-down direction in the illustrated embodiment. In this case, the one direction may be a direction parallel to a direction in which the water purifier faucet 72 (shown in FIG. 7A) moves to be accommodated in the housing 52 (shown in FIG. 7A). This will be described in detail with reference to FIG. 7A.

Meanwhile, a first-1 lower wing plate 122 may be foldably connected to one side portion, for example, a lower side portion as in the embodiment shown in FIG. 3C, of the first rear surface plate 120. To this end, a first-1 lower wing folding line F122 may be provided between the first rear surface plate 120 and the first-1 lower wing plate 122.

The first-1 lower wing plate 122 may overlap with the first bottom surface plate 140 to be described later, thereby reinforcing the bearing capacity of the first bottom surface plate 140 and increasing the structural stability of the first box structure 50 (or housing 52 (shown in FIG. 7A)).

Meanwhile, a first-1 top surface cover plate 124 may be foldably connected to yet another side portion, that is, an upper side portion based on FIG. 3A, of the first rear surface plate 120. To this end, a first-1 top surface cover folding line F124 may be provided between the first-1 top surface cover plate 124 and the first rear surface plate 120.

The first-1 top surface cover plate 124 may move up and down to open and close the upper portion of a first accommodation space S1, which will be described later. In a state in which the first-1 top surface cover plate 124 is moved upward, the second box structure 60 (or the water purifier faucet 72 (shown in FIG. 7A)) may enter and exit through the upper portion of the first accommodation space S1.

In a state in which the first-1 top surface cover plate 124 is moved downward to cover the upper portion of the first accommodation space S1, the upper side portion of the second box structure 60 (or the water purifier faucet 72 (shown in FIG. 7A)) may be protected from the outside.

Referring to FIGS. 3A and 3B, a first-2 side surface plate 130 may be foldably connected to another side portion, for example, a left side portion based on FIG. 3A, of the first rear surface plate 120. To this end, a first-2 side surface folding line F130 may be provided between the first-2 side surface plate 130 and the first rear surface plate 120.

The first-2 side surface plate 130 is configured to form the sidewall of the first box structure 50, and may be bent to be parallel with the first-1 side surface plate 110. In this case, a filter entrance and exit part 131 may be formed on the first-2 side surface plate 130.

The filter entrance and exit part 131 may mean a portion formed by cutting the central portion of the first-2 side surface plate 130 so that a predetermined object can pass through the first-2 side surface plate 130.

As will be described later in detail, in the water purifier assembled state, the filter 40 may enter and exit the inside of the housing 52 (shown in FIG. 7A) and the water purifier faucet 72 (shown in FIG. 7A) through the filter entrance and exit part 131. Accordingly, the filter 40 may be easily replaced or maintained.

A fixing protrusion insertion part 141 may be formed on the first-2 side surface plate 130. In the illustrated embodiment, the fixing protrusion insertion part 141 is formed at a lower portion of the first-2 side surface plate 130. The fixing protrusion insertion part 141 may be formed in a hole or groove shape.

Meanwhile, the first bottom surface plate 140 may be foldably connected to one side portion, for example, a lower side portion based on FIG. 3A, of the first-2 side surface plate 130. To this end, a first bottom surface folding line F140 may be provided between the first-2 side surface plate 130 and the first bottom surface plate 140.

The first bottom surface plate 140 is configured to form the bottom of the first box structure 50, and may be bent perpendicularly to the first-1 and first-2 side surface plates 110 and 130. The first bottom surface plate 140 may support components accommodated in the first box structure 50 (or the housing 52 (shown in FIG. 7A)).

A first front surface plate 150 may be foldably connected to another side portion, for example, a left side portion based on FIG. 3A, of the first-2 side surface plate 130. To this end, a first front surface folding line F150 may be provided between the first front surface plate 150 and the first-2 side surface plate 130.

The first front surface plate 150 is configured to form the front surface of the first box structure 50. Referring to FIG. 3C, a first accommodation space S1 defined by the first-1 side surface plate 110, the first rear surface plate 120, the first-2 side surface plate 130, the first bottom surface plate 140, and the first front surface plate 150 may be provided inside the first box structure 50.

In the first accommodation space S1, the second box structure 60 may be accommodated and protected in the packaged state, and the water purifier faucet 72 (shown in FIG. 7A) may be accommodated and protected in the water purifier assembled state. As described above, the side portion of the first accommodation space S1 may communicate with the outside through the filter entrance and exit part 131.

In this case, the first front surface plate 150 may be formed to have a shorter length in the up-down direction than the first rear surface plate 120 described above. Through this, in the water purifier assembled state, a water outlet unit 610 (shown in FIG. 7A) to be described below may protrude forward through one side, for example, through the upper side based on FIG. 3C, of the first front surface plate 150.

Meanwhile, a first-2 lower wing plate 154 and a first side wing plate 152 may be foldably connected to one side portion and the other side portion, for example, a lower side portion and an upper side portion based on FIG. 3A, of the first front surface plate 150, respectively.

To this end, a first-2 lower wing folding line F154 may be provided between the first front surface plate 150 and the first-2 lower wing plate 154, and a first side wing folding line F152 may be provided between the first front surface plate 150 and the first side wing plate 152.

The first side wing plate 152 may overlap with the first-1 side surface plate 110, thereby reinforcing the bearing capacity of the first-1 side surface plate 110 and increasing the structural stability of the first box structure 50 (or housing 52 (shown in FIG. 7A)).

In addition, the first-2 lower wing plate 154 may overlap with the first bottom surface plate 140, thereby reinforcing the bearing capacity of the first bottom surface plate 140 and increasing the structural stability of the first box structure 50 (or housing 52 (shown in FIG. 7A)).

Meanwhile, referring back to FIGS. 3A and 3C, a cover part 160 may be provided on yet another side portion, for example, on the upper side portion based on FIG. 3A, of the first-1 side surface plate 110 to open and close the open portion of the first accommodation space S1.

The cover part 160 may include a first-2 top surface cover plate 162 for opening and closing one open side, for example, an upper side based on FIG. 3C, of the first accommodation space S1, and a first side surface cover plate 164 for opening and closing the filter entrance and exit part 131 formed in the first-2 side surface plate 130.

That is, in the present embodiment, based on FIG. 3A, the first-2 top surface cover plate 162 may be foldably connected to the upper side portion of the first-1 side surface plate 110, and the first side surface cover plate 164 may be foldably connected to the upper side portion of the first-2 top surface cover plate 162.

To this end, a first-2 top surface cover folding line F162 may be provided between the first-1 side surface plate 110 and the first-2 top surface cover plate 162, and a first side surface cover folding line F164 may be provided between the first-2 top surface cover plate 162 and the first side surface cover plate 164.

Accordingly, the first-2 top surface cover plate 162 may move in the up-down direction to open and close the upper portion of the first accommodation space S1, and the first side surface cover plate 164 may move in the up-down direction to open and close the filter entrance and exit part 131.

Meanwhile, a fixing protrusion 165 may be formed on one side portion, i.e., the upper side portion based on FIG. 3A, of the first side surface cover plate 164. The fixing protrusion 165 may be fitted and coupled to the aforementioned fixing protrusion insertion part 141 in a state in which the cover part 160 closes the first accommodation space S1.

When the fixing protrusion 165 is coupled to the fixing protrusion insertion part 141, the position of the cover part 160 is fixed so that the closed state of the first accommodation space S1 can be stably maintained. Accordingly, the user can easily control whether to open or close the first accommodation space S1 using the fixing protrusion 165.

Meanwhile, referring to FIGS. 3A and 3C, a water outlet unit cover part 170 may be provided on yet another side portion, for example, the upper side portion based on FIG. 3A, of the first front surface plate 150. The water outlet unit cover part 170 may include a water outlet unit bottom surface plate 171, a water outlet unit front surface plate 174, a water outlet unit top surface plate 175, and first and second water outlet unit side surface plates 176 and 178.

The water outlet unit cover part 170 constitutes a part of the first box structure 50 in the packaged state, and is configured to cover and protect one edge portion of the second box structure 60. However, the water outlet unit cover part 170 may constitute a part of the housing 52 (shown in FIG. 7A) in the water purifier assembled state, and cover the water outlet unit 610 (shown in FIG. 7A) to be described later, thereby protecting it from the outside and improving aesthetics.

More specifically, in the present embodiment, as shown in FIG. 3A, the water outlet unit bottom surface plate 171 may be foldably connected to the upper side portion of the first front surface plate 150. To this end, a water outlet unit bottom surface folding line F171 may be provided between the first front surface plate 150 and the water outlet unit bottom surface plate 171.

In this case, the vertical length of the water outlet unit bottom surface plate 171 may be formed to correspond to the vertical length difference between the first rear surface plate 120 and the first front surface plate 150. Accordingly, as shown in FIG. 3B, the water outlet unit bottom surface plate 171 may cover and protect the front portion of the second box structure 60 together with the first front surface plate 150 in the packaged state.

A water outlet hole 171a may be formed in the central portion of the water outlet unit bottom surface plate 171. The specific function of the water outlet hole 171a will be described later with reference to FIG. 7A.

A first water outlet unit wing plate 172 and a second water outlet unit wing plate 173 may be foldably connected to one side portion and the other side portion, for example, a left side portion and a right side portion based on FIG. 3A, of the water outlet unit bottom surface plate 171, respectively.

To this end, a first water outlet unit wing folding line F172 may be provided between the water outlet unit bottom surface plate 171 and the first water outlet unit wing plate 172, and a second water outlet unit wing folding line F173 may be provided between the water outlet unit bottom surface plate 171 and the second water outlet unit wing plate 173.

The first and second water outlet unit wing plates 172 and 173 may overlap with the first-1 and first-2 side surface plates 110 and 130, respectively, in the packaged state, thereby reinforcing the bearing capacity of the first-1 and first-2 side surface plates 110 and 130 and also increasing the structural stability of the first box structure 50.

However, the first and second water outlet unit wing plates 172 and 173 may overlap with first and second water outlet unit side surface plates 176 and 178 to be described later, respectively, in the water purifier assembled state, thereby perform a function of increasing the structural stability of the water outlet unit cover part 170.

Meanwhile, referring to FIGS. 3A and 3C, the water outlet unit front surface plate 174 may be foldably connected to another side portion, for example, the upper side portion based on FIG. 3A, of the water outlet unit bottom surface plate 171.

To this end, water outlet unit front surface folding lines F174a and F174b may be provided between the water outlet unit bottom surface plate 171 and the water outlet unit front surface plate 174. In this case, the water outlet unit front surface folding lines F174a and F174b may include a first water outlet unit front surface folding line F174a and a second water outlet unit front surface folding line F174b extending in parallel with each other at a predetermined interval. This will be described with reference to FIG. 7A.

In this case, as seen in FIG. 3A, in the present embodiment, the vertical length of the water outlet unit front surface plate 174 may correspond to a difference between the vertical length of the first rear surface plate 120 and the vertical length of the first front surface plate 150. Preferably, the vertical length of the water outlet unit front surface plate 174 may be equal or slightly larger than the difference between the vertical length of the first rear surface plate 120 and the vertical length of the first front surface plate 150.

Accordingly, when the first box structure 50 is reassembled into the housing 52 (shown in FIG. 7A), the height of the upper side portion of the water outlet unit front surface plate 174 constituting the front portion of the water outlet unit cover part 170 may be in harmony with the height of the upper side portion of the first rear surface plate 120.

The water outlet unit top surface plate 175 may be foldably connected to one side portion, for example, the upper side portion based on FIG. 3A, of the water outlet unit front surface plate 174. To this end, a water outlet unit top surface folding line F175 may be provided between the water outlet unit front surface plate 174 and the water outlet unit top surface plate 175. An operation unit through-hole 175a may be formed in the water outlet unit top surface plate 175. The specific function of the water outlet unit top surface plate 175 will be described later with reference to FIG. 7B.

The water outlet unit front surface plate 174 and the water outlet unit top surface plate 175 may be arranged in parallel with each other to cover the upper portion of the first accommodation space S1 in the packaged state, thereby protecting the upper portion of the second box structure 60 disposed in the first accommodation space S1.

In addition, the water outlet unit front surface plate 174 and the water outlet unit top surface plate 175 may move in the up-down direction and perform a function of opening and closing the upper portion of the first accommodation space S1 together with the first-1 and first-2 top surface cover plates 124 and 162.

First and second water outlet unit side surface plates 176 and 178 may be foldably connected to one side portion and the other side portion, for example, a left side portion and a right side portion based on FIG. 3A, of the water outlet unit top surface plate 175, respectively.

To this end, a first water outlet unit side surface folding line F176 may be provided between the water outlet unit top surface plate 175 and the first water outlet unit side surface plate 176, and a second water outlet unit side surface folding line F178 may be provided between the water outlet unit top surface plate 175 and the second water outlet unit side surface plate 178.

A third water outlet unit wing plate 177 may be foldably connected to one side portion, for example, a lower side portion based on FIG. 3A, of the first water outlet unit side surface plate 176. To this end, a third water outlet unit wing folding line F177 may be provided between the first water outlet unit side surface plate 176 and the third water outlet unit wing plate 177.

In addition, a fourth water outlet unit wing plate 179 may be foldably connected to one side portion, for example, a lower side portion based on FIG. 3A, of the second water outlet unit side surface plate 178. To this end, a fourth water outlet unit wing folding line F179 may be provided between the second water outlet unit side surface plate 178 and the fourth water outlet unit wing plate 179.

The first and second water outlet unit side surface plates 176 and 178 and the third and fourth water outlet unit wing plates 177 and 179 may overlap with any one of the first-1 and first-2 side surface plates 110 and 130, respectively, in the packaged state, thereby reinforcing the bearing capacity of the first-1 and first-2 side surface plates 110 and 130 and increasing the structural stability of the first box structure 50.

As seen above, according to the present embodiment, the first box structure 50 may protect the second box structure 60 and other components accommodated therein by taking them out to the outside or accommodating them inside as needed.

In addition, at least a part of the inner surface and/or at least a part of the outer surface of the first box structure 50 (or the housing 52 (shown in FIG. 7A)) may be treated with a waterproof coating to enhance water resistance. In other words, a waterproof layer having a waterproof function may be provided on at least a part of the inner surface and/or at least a part of the outer surface of the first box structure 50 (or the housing 52 (shown in FIG. 7A)).

The first box structure assembling cardboard 100 shown in FIG. 3A is only an example, and a method in which the above-described plurality of plates are connected to each other may be variously changed within a range that does not impair the idea of the present invention. For example, in FIG. 3A, the first front surface plate 150 is configured to be connected to the left side portion of the first-2 side surface plate 130, but the first front surface plate 150 may be configured to be connected to the right side of the first-1 side surface plate 110 as needed.

In addition, in the present embodiment, the first box structure assembling cardboard 100 is made of a paper material, but may be made of a material having other properties as needed. For example, it may be made of a material such as plastic having a certain degree of rigidity and waterproofness but having some flexibility.

Meanwhile, the water outlet unit cover part 170 may be referred to as a water outlet member cover part, the water outlet unit bottom surface plate 171 may be referred to as a water outlet member bottom surface plate, the water outlet unit front surface plate 174 may be referred to as a water outlet member front surface plate, the water outlet unit top surface plate 175 may be referred to as a water outlet member top surface plate, and the first water outlet unit side surface plate 176 and the second water outlet unit side surface plate 178 may be referred to as a first water outlet member side surface plate and a second water outlet member side surface plate, respectively.

Hereinafter, the second box structure according to an embodiment of the present invention will be described in detail.

FIG. 4A is a plan view of a second box structure assembling cardboard according to an exemplary embodiment of the present invention. FIG. 4B is a view illustrating a process of taking out a water purifier faucet assembly kit according to an exemplary embodiment of the present invention by opening a second box structure according to an exemplary embodiment of the present invention. FIGS. 4C and 4D are views for explaining a process of reassembling a second box structure according to an exemplary embodiment of the present invention into a reinforcing frame and a cup holder.

Referring to FIGS. 4A to 4D, as described above, the second box structure 60 according to the present embodiment is configured to accommodate and protect the water purifier faucet assembly kit 70 in the packaged state. In addition, as will be described later, the first box structure 50 can be reassembled into the reinforcing frame 62 and the cup holder 64 in the water purifier assembled state and function as a component of the water purifier.

In the present embodiment, the second box structure 60 may be formed by assembling a second box structure assembling cardboard 200. As shown in FIG. 4A, the second box structure 60 according to the present embodiment may be manufactured by bending each part of the second box structure assembling cardboard 200 along a folding line to be described later or by cutting along a cutting line to be described later.

One part of the second box structure assembling cardboard 200 can be easily bent at a predetermined angle with the other part by the folding line. The process of forming the above-described cutting and folding lines may be performed by a punching process of punching a predetermined cardboard, or the like.

In this case, the second box structure assembling cardboard 200 may be a flat plate made of paper. For example, the second box structure assembling cardboard 200 may be manufactured by forming cut and groove through a punching process of hard cardboard or corrugated cardboard. Accordingly, according to the present embodiment, even if the second box structure 60 is discarded after use, it can be easily decomposed in nature, and thus environmental pollution due to waste can be prevented.

Referring to FIGS. 4A and 4B, the second box structure assembling cardboard 200 according to an embodiment of the present invention may be formed of a plurality of flat plates that are connected to be foldable to each other. In this case, some of the plurality of plates may be connected to each other to be cut.

In the present embodiment, the second box structure assembling cardboard 200 may include a second-1 side surface plate 210 forming a bottom surface of the second box structure 60. The second-1 side surface plate 210 may be formed of a quadrangular flat plate having a predetermined thickness. The second-1 side surface plate 210 may support and protect the lower portion of the water purifier faucet assembly kit 70 accommodated inside the second box structure 60.

A second lower front surface fixing protrusion hole 211 and a second upper front surface fixing protrusion hole 213 may be formed in the up-down direction at one edge portion, for example, at a right side edge portion based on FIG. 4A, of the second-1 side surface plate 210. In this case, the second lower front surface fixing protrusion hole 211 may be positioned at a relatively lower side, and the second upper front surface fixing protrusion hole 213 may be positioned at a relatively upper side.

In addition, a second lower rear surface fixing protrusion hole 215 and a second upper rear surface fixing protrusion hole 217 may be formed in the up-down direction at another edge portion, for example, at a left side edge portion based on FIG. 4A, of the second-1 side surface plate 210. In this case, the second lower rear surface fixing protrusion hole 215 may be positioned at a relatively lower side, and the second upper rear surface fixing protrusion hole 217 may be positioned at a relatively upper side.

A second front surface plate 220a, 220b may be foldably connected to one side portion, that is, a right side portion based on FIG. 4A, of the second-1 side surface plate 210. To this end, a second front surface folding line F220 may be provided between the second-1 side surface plate 210 and the second front surface plate 220a, 220b.

The second front surface plate 220a, 220b may constitute the front surface of the second box structure 60, thereby supporting and protecting the front portion of the water purifier faucet assembly kit 70 accommodated inside the second box structure 60.

In this case, a second front surface plate cutting line C220 may be formed on the second front plate 220a, 220b. The second front surface plate cutting line C220 may be formed between the second lower front surface fixing protrusion hole 211 and the second upper front surface fixing protrusion hole 213 along one direction, for example, the horizontal direction based on FIG. 4A, to cross the second front surface plate 220a, 220b.

By the second front surface plate cutting line C220, the second front surface plate 220a, 220b may be separated into a second lower front surface plate 220a and a second upper front surface plate 220b. To this end, the second front surface plate cutting line C220 may be provided in a pre-processed state so that a user can easily cut it.

Referring to FIGS. 4A and 4B, a second front surface cover plate 222a, 222b may be foldably connected to one side portion, for example, a right side portion based on FIG. 4A, of the second front surface plate 220a, 220b. To this end, second front surface cover folding lines F222a and F222b may be provided between the second front surface plate 220a, 220b and the second front surface cover plate 222a, 222b.

The second front surface cover plate 222a, 222b may be disposed overlapping to cover one surface of the second front surface plate 220a, 220b, thereby supplementing the bearing capacity of the second front surface plate 220a and 220b and increasing the structural stability of the second box structure 60.

In this case, the second front surface cover folding lines F222a and F222b may include a second-1 front surface cover folding line F222a and a second-2 front surface cover folding line F222b that are spaced apart by a predetermined distance and extend parallel to each other.

The second front surface cover plate 222a, 222b may be bent along the second-1 front surface cover folding line F222a and disposed to cross the second front surface plate 220a, 220b, and may be bent along the second-2 front surface cover folding line F222b and disposed parallel to the second front surface plate 220a, 220b. Accordingly, the second front surface cover plate 222a, 222b may be disposed overlapping to more easily cover one surface of the second front surface plate 220a, 220b.

Meanwhile, a second front surface cover plate cutting line C222 may be formed on the second front surface plate 222a, 222b. The second front surface cover plate cutting line C222 may be formed to be connected to one end of the above-described second front surface plate cutting line C220 and to cross the second front surface cover plate 222a, 222b along one direction, for example, a horizontal direction based on FIG. 4.

By the second front surface cover plate cutting line C222, the second front surface cover plate 222a, 222b may be separated into a second lower front surface cover plate 222a and a second upper front surface cover plate 222b. Likewise, the second front surface cover plate cutting line C222 may be provided in a pre-processed state so that a user can easily cut it.

A second lower front surface fixing protrusion 224a to be fitted and coupled into the aforementioned second lower front surface fixing protrusion hole 211 may be formed on one side portion, for example, a right side portion based on FIG. 4A, of the second lower front surface cover plate 222a.

Similarly, a second upper front surface fixing protrusion 224b to be fitted and coupled into the aforementioned second upper front surface fixing protrusion hole 213 may be formed on one side portion, for example, a right side portion based on FIG. 4A, of the second upper front surface cover plate 222b.

The second lower front surface fixing protrusion 224a and the second upper front surface fixing protrusion 224b are fitted and coupled into the aforementioned second lower front surface fixing protrusion hole 211 and second upper front surface fixing protrusion hole 213, respectively, and thus, the position of the second front surface cover plate 222a, 222b can be stably fixed.

Referring to FIGS. 4A and 4B, a second rear surface plate 230 may be foldably connected to another side portion, for example, a left side portion based on FIG. 4A, of the second-1 side surface plate 210. To this end, a second rear surface folding line F230 may be provided between the second-1 side surface plate 210 and the second rear surface plate 230.

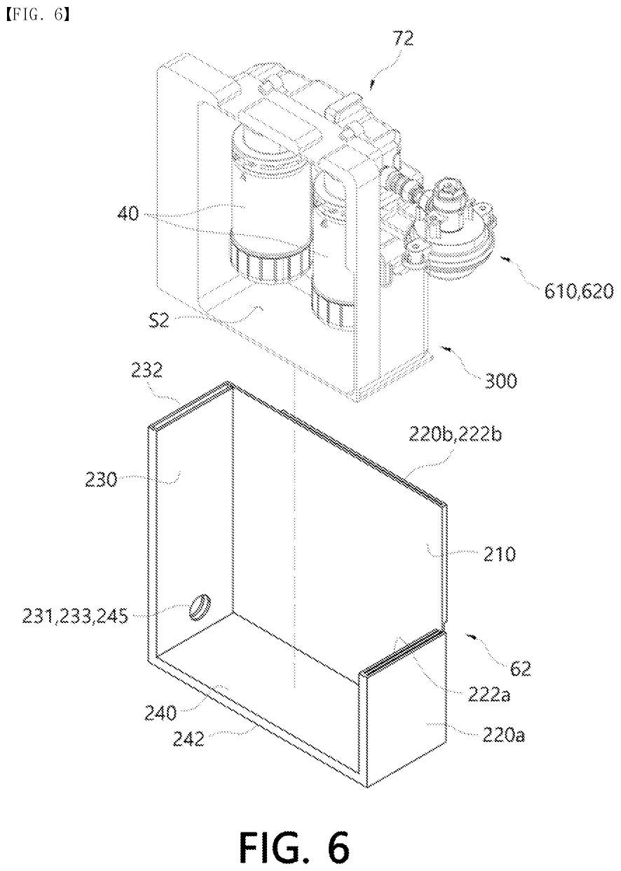

The second rear surface plate 230 may constitute the rear surface of the second box structure 60, thereby supporting the rear portion of the water purifier faucet assembly kit 70 accommodated inside the second box structure 60. A second-1 water inlet module through-hole 231 may be formed in the second rear surface plate 230. This will be described with reference to FIG. 6.

Meanwhile, a second rear surface cover plate 232 may be foldably connected to one side portion, for example, a left side portion based on FIG. 4A, of the second rear surface plate 230. To this end, second rear surface cover folding lines F232a and F232b may be provided between the second rear surface plate 230 and the second rear surface cover plate 232.

The second rear surface cover plate 232 may be disposed overlapping to cover one surface of the second rear surface plate 230, thereby supplementing the bearing capacity of the second rear surface plate 230 and increasing the structural stability of the second box structure 60.

In this case, the second rear surface cover folding lines F232a and F232b may include a second-1 rear surface cover folding line F232a and a second-2 rear surface cover folding line F232b that are spaced apart by a predetermined distance and extend parallel to each other.

The second rear surface cover plate 232 may be bent along the second-1 rear surface cover folding line F232a and disposed to cross the second rear surface plate 230, and may be bent along the second-2 rear surface cover folding line F232b and disposed parallel to the second rear surface plate 230. Accordingly, the second rear surface cover plate 232 may be disposed overlapping so as to more easily cover one surface of the second rear surface plate 230.

In this case, a second lower rear surface fixing protrusion 234a to be fitted and coupled into the aforementioned second lower rear surface fixing protrusion hole 215 and a second upper rear fixing protrusion hole 234b to be fitted and coupled into the second upper rear surface fixing protrusion hole 217 may be formed on one side portion, for example, a left side portion based on FIG. 4A, of the second rear surface cover plate 232.

The second lower rear surface fixing protrusion 234a and the second upper rear surface fixing protrusion 234b are fitted and coupled into the aforementioned second lower rear surface fixing protrusion hole 215 and second upper rear surface fixing protrusion hole 217, respectively, and thus, the position of the second rear surface cover plate 232 can be stably fixed.

Meanwhile, a second-2 water inlet module through-hole 233 may be formed in the second rear surface cover plate 232. In this case, the position of the second-2 water inlet module through-hole 233 may be adjusted so that the second rear surface plate 230 and the second rear surface cover plate 232 are coaxially arranged with each other in a state in which they are positioned so as to overlap.

Accordingly, a predetermined object may simultaneously pass through the second-1 and second-2 water inlet module through-holes 231 and 233 in a state where the second rear surface plate 230 and the second rear surface cover plate 232 are positioned to overlap each other. The specific function of the second-2 water inlet module through-hole 233 will be described later with reference to FIG. 6.

Referring back to FIGS. 4A and 4B, a second bottom surface plate 240 may be foldably connected to another side portion, for example, a lower side portion based on FIG. 4A, of the second-1 side surface plate 210. To this end, a second bottom surface folding line F240 may be provided between the second bottom surface plate 240 and the second-1 side surface plate 210.

The second bottom surface plate 240 may constitute one sidewall of the second box structure 60, thereby supporting one side portion of the water purifier faucet assembly kit 70 accommodated inside the second box structure 60.

A second-1 bottom surface wing plate 244 and a second-2 bottom surface wing plate 246 may be foldably connected to one side portion and the other side portion, for example, a left side portion and a right side portion based on FIG. 4A, of the second bottom surface plate 240, respectively.

To this end, a second-1 bottom surface wing folding line F244 may be provided between the second bottom surface plate 240 and the second-1 bottom surface wing plate 244, and a second-2 bottom surface wing folding line F246 may be provided between the second bottom surface plate 240 and the second-2 bottom surface wing plate 246.

The second-1 and second-2 bottom surface wing plates 244 and 246 may be disposed to overlap the second rear surface plate 230 and the second front surface plate 220a, 220b, respectively, in the packaged state. For example, the second-1 bottom surface wing plate 244 may be disposed between the second rear surface plate 230 and the second rear surface cover plate 232, and the second-2 bottom surface wing plate 246 may be disposed between the second front surface plate 220a, 220b and the second front surface cover plate 222a, 222b.

Through this, the second-1 and second-2 bottom surface wing plates 244 and 246 may supplement the bearing capacity of the second rear surface plate 230 and the second front surface plate 220a, 220b, respectively, and increase the structural stability of the second box structure 60.

In this case, a second-3 water inlet module through-hole 245 may be formed in the second-1 bottom surface wing plate 244. The position of the second-3 water inlet module through-hole 245 may be adjusted so that the second-1 bottom surface wing plate 244 is coaxially arranged with the second rear surface plate 230 and the second rear surface cover plate 232 in a state in which the second-1 bottom surface wing plate 244 is positioned to overlap with the second rear surface plate 230 and the second rear surface cover plate 232.

Accordingly, a predetermined object may simultaneously pass through the second-1 to second-3 water inlet module through-holes 231, 233, and 245 in a state where the second rear surface plate 230, the second rear surface cover plate 232, and the second-1 bottom surface wing plate 244 are positioned to overlap each other. The specific function of the second-3 water inlet module through-hole 245 will be described later with reference to FIG. 6.

Meanwhile, a second-1 bottom surface cover plate 242 may be foldably connected to another side portion, for example, a lower side portion based on FIG. 4A, of the second bottom surface plate 240. To this end, second-1 bottom surface cover folding lines F242a and F242b may be provided between the second bottom surface plate 240 and the second-1 bottom surface cover plate 242.

The second-1 bottom surface cover plate 242 may be disposed overlapping to cover one surface of the second bottom surface plate 240, thereby supplementing the bearing capacity of the second bottom surface plate 240 and increasing the structural stability of the second box structure 60.

In this case, the second-1 bottom surface cover folding lines F242a and F242b may include a second-1-1 bottom surface cover folding line F242a and a second-1-2 bottom surface cover folding line F242b that are spaced apart by a predetermined distance and extend parallel to each other.

The second-1 bottom surface cover plate 242 may be bent along the second-1-1 bottom surface cover folding line F242a and disposed to cross the second bottom surface plate 240, and may be bent along the second-1-2 bottom surface cover folding line F242b and disposed parallel to the second bottom surface plate 240. Accordingly, the second-1 bottom surface cover plate 242 may be disposed overlapping to more easily cover one surface of the second bottom surface plate 240.

Referring back to FIGS. 4A and 4B, a second top surface plate 250 may be foldably connected to yet another side portion, for example, an upper side portion based on FIG. 4A, of the second-1 side surface plate 210.

The second top surface plate 250 may constitute the other sidewall of the second box structure 60, thereby supporting the other side portion of the water purifier faucet assembly kit 70 accommodated inside the second box structure 60.

In this case, a second top surface cutting line C250 may be provided between the second-1 side surface plate 210 and the second top surface plate 250 so that the second top surface plate 250 can be bent by the second-1 side surface plate 210 by a relatively weak external force, but the second top surface plate 250 and the second-1 side surface plate 210 can be separated from each other by a relatively strong external force. The second top surface cutting line C250 may be provided in a pre-processed state so that a user can easily cut it.

A second top surface folding line F250 may be formed at a central portion of the second top surface plate 250 to be spaced apart from a holder part folding line F262 by a predetermined distance but extending parallel to each other. The function of the second top surface folding line F250 will be described later with reference to FIGS. 4C and 4D.

Meanwhile, second-1 and second-2 top surface wing plates 252 and 254 may be foldably connected to one side portion and the other side portion, for example, a left side portion and a right side portion based on FIG. 4A, of the second top surface plate 250.

To this end, a second-1 top surface wing folding line F252 may be provided between the second top surface plate 250 and the second-1 top surface wing plate 252, and a second-2 top surface wing folding line F254 may be provided between the second top surface plate 250 and the second-2 top surface wing plate 254.

The second-1 and second-2 top surface wing plates 252 and 254 may be disposed to overlap the second rear surface plate 230 and the second front surface plate 220a, 220b, respectively, in the packaged state. For example, the second-1 top surface wing plate 252 may be inserted and disposed between the second rear surface plate 230 and the second rear surface cover plate 232 disposed to overlap each other, and the second-2 top surface wing plate 254 may be inserted and disposed between the second front surface plate 220a, 220b and the second front surface cover plate 222a, 222b to be disposed to overlap each other.

Through this, the second-1 and second-2 top surface wing plates 252 and 254 may supplement the bearing capacity of the second rear surface plate 230 and the second front surface plate 220a, 220b, respectively, and increase the structural stability of the second box structure 60.

Referring back to FIGS. 4A and 4B, a second-2 side surface plate 260 may be foldably connected to yet another side portion, for example, an upper side portion based on FIG. 4A, of the second top surface plate 250.

The second-2 side surface plate 260 may move up and down in the packaged state to open and close the inner space of the second box structure 60. In a state in which the second-2 side surface plate 260 is moved upward based on FIG. 4B, the water purifier faucet assembly kit 70 can enter and exit through the upper portion of the second box structure 60.

Meanwhile, the second-2 side surface plate 260 may include a holder part 262 and a folding part 264. The holder part 262 is a part where a cup is supported in the water purifier assembled state, and may be disposed to be in contact with the above-described second top surface plate 250. That is, a holder part folding line F262 may be provided between the holder part 262 and the second top surface plate 250.

A circular support hole cutting line C263 may be formed in the holder part 262. As the support hole cutting line C263 is cut by an external force, a support hole 263 to be described later may be formed in the holder part 262. The support hole cutting line C263 may be provided in a pre-processed state so that a user can easily cut it.

In the present embodiment, it is exemplified that there are two support hole cutting lines C263, but the number is not particularly limited and may be provided in zero or more. In addition, the shape of the support hole cutting line C263 may be variously modified according to the shape of the support hole 263 to be formed.

The folding part 264 is a part that is bent in one direction to support the holder part 262 in the water purifier assembled state, and may be disposed to face the second top surface plate 250 with the holder part 262 as the center. However, the relative positional relationship between the holder part 262 and the second top surface plate 250 is not limited to the above-described positional relationship.

Folding part folding lines F264a and F264b parallel to the holder part folding line F262 may be provided between the holder part 262 and the folding part 264. In this case, the folding part folding lines F264a and F264b may include a first folding part folding line F264a and a second folding part folding line F264b that are spaced apart from each other by a predetermined distance and extend in parallel with each other.

In this case, the separation distance between the second top surface folding line F250 and the holder part folding line F262 and the separation distance between the first folding part folding line F264a and the second folding part folding line F264b may correspond to each other. For example, both distances may be provided equal to each other. The function of the folding part folding lines F264a and F264b will be described later with reference to FIGS. 4C and 4D.

A second-2 bottom surface cover plate 270 may be foldably connected to one side portion, for example, an upper side portion based on FIG. 4A, of the second-2 side surface plate 260. The second-2 bottom surface cover plate 270 may function as a handle for allowing a user to move the second-2 side surface plate 260.

In this case, a second-2 bottom surface cover cutting line C270 may be provided between the second-2 side surface plate 260 and the second-2 bottom surface cover plate 270 so that the second-2 bottom surface cover plate 270 can be bent with respect to the second-2 side surface plate 260 by a relatively weak external force, but the second-2 side surface plate 260 and the second-2 bottom surface cover plate 270 can be separated from each other by a relatively strong external force. The second-2 bottom surface cover cutting line C270 may be provided in a pre-processed state so that a user can easily cut it.

First and second coupling protrusions 272 and 274 may be provided on one side portion and the other side portion, for example, a left side portion and a right side portion based on FIG. 4A, of the second-2 bottom surface cover plate 270, respectively. In the packaged state, the first coupling protrusion 272 may be fitted and coupled between the second rear surface plate 230 and the second rear surface cover plate 232, and the second coupling protrusion 274 may be fitted and coupled between the second front surface plate 220a, 220b and the second front surface cover plate 222a, 222b.

By fitting and coupling the first and second coupling protrusions 272 and 274, the second-2 bottom surface cover plate 270 and the second-2 side surface plate 260 may be fixed in position to close the inner space of the second box structure 60.

As seen above, according to the present embodiment, the second box structure 60 may protect the water purifier faucet assembly kit 70 by taking it out to the outside or accommodating it inside as needed.

Hereinafter, according to an embodiment of the present invention, a process of reassembling the second box structure 60 in the packaged state into a reinforcing frame 62 and a cup holder 64 in the water purifier assembled state will be described.

According to an embodiment of the present invention, a portion of the second box structure 60 may be cut and bent in a predetermined manner to form a reinforcing frame 62 and a cup holder 64.

The reinforcing frame 62 may be interposed between a portion of an outer surface of a water purifier faucet and a portion of an inner surface of a housing to fix the water purifier faucet to a first accommodation space inside the housing.

To this end, the reinforcing frame 62 may include a reinforcing part covering a portion of an outer surface of the water purifier faucet; a bent part that is bent outward from one side portion of the reinforcing part; and an extension part extending from the bent part and having one surface facing the outer surface of the reinforcing part.

Referring to FIGS. 4A and 4C, in the present embodiment, as the second box structure 60 is cut along the second top surface cutting line C250, the second box structure 60 may be separated into a reinforcing frame part including the second-1 side surface plate 210, the second front surface plate 220a, 220b, the second rear surface plate 230, and the second bottom surface plate 240; and a cup holder part including the second top surface plate 250, the second-2 side surface plate 260, and the second-2 bottom surface cover plate 270.

In this case, each component of the reinforcing frame part forms the same assembly relationship as the packaged state, but the second front surface plate 220a, 220b and the second front surface cover plate 222a, 222b may be reassembled.

In this case, the reinforcing part may include a second-1 side surface plate 210, a second rear surface plate 230, a second rear surface cover plate 232, a second bottom surface plate 240, a second-1 bottom surface cover plate 242, and a soon-to-be described second lower front surface plate 220a and second lower front surface cover plate 222a. The reinforcing part may have a structure shape in which one side surface, the rear surface, the bottom surface, and the front surface are formed, and the other side surface opposite to one side surface and the top surface are open. The reinforcing part may respectively cover a part of one side surface, the rear surface, the bottom surface, and the front surface of a water purifier faucet, which will be described later.

The second front surface plate 220a, 220b may be cut along the second front surface cutting line C220 and separated into a second lower front surface plate 220a and a second upper front surface plate 220b. In addition, the second front surface cover plate 222a, 222b may be cut along the second front surface cover cutting line C222 and separated into a second lower front surface cover plate 222a and a second upper front surface cover plate 222b.

Accordingly, the second lower front surface plate 220a and the second lower front surface cover plate 222a may be connected to each other, and the second upper front surface plate 220b and the second upper front surface cover plate 222b may be connected to each other, but the second lower front surface plate 220a and the second lower front surface cover plate 222a, the second upper front surface plate 220b and the second upper front surface cover plate 222b may be independent of each other.

The second lower front surface cover plate 222a may be bent to face the inner surface of the second lower front surface plate 220a to form the front surface of the aforementioned reinforcing part.

The second upper front surface plate 220a and the second upper front surface cover plate 222b may be bent in an outward direction of the reinforcing part. In this case, the second upper front surface plate 220a and the second upper front surface cover plate 222b extending from the reinforcing part are referred to as an extension part. A bent part may be provided between the extension part and the reinforcing part so that the extension direction of the extension part may be changed.

In this case, one surface of the extension part, that is, the second upper front surface plate 220a and the second upper front surface cover plate 222b may be disposed to face the outer surface of the second-1 side surface plate 210 of the reinforcing part.

By the restoring force of the bent part deformed to be bent, the extension part may try to move away from the second-1 side surface plate 210 and press the inner wall of the housing, and the reinforcing part may be pressed forward by the reaction force. Accordingly, the reinforcing part and the water purifier faucet disposed in the reinforcing part may come into close contact with the inner surface of the housing and be fixed in position within the first accommodation space.

In this case, referring back to FIGS. 4C and 4D, the second upper front surface plate 220b and the second upper front surface cover plate 222b may be bent outward to face the outer surface of the second-1 side surface plate 210 to form a reinforcing frame 62.

Meanwhile, the cup holder part may be cut along the second-2 bottom surface cover cutting line C270, so that the second-2 bottom surface cover plate 270 may be separated from the second-2 side surface plate 260.

In this case, the second top surface plate 250 may be bent along the holder part folding line F262 and disposed to cross the holder part 262, and may be bent along the second top surface folding line F262 and disposed parallel to the holder part 262.

In addition, the folding part 264 may be bent along the first folding part folding line F264a and disposed to cross the holder part 262, and may be bent along the second folding part folding line F264b and disposed parallel to the holder part 262.

Meanwhile, as described above, a portion of the holder part 262 may be cut and separated along the support hole cutting line C263 to form in the holder part 262a support hole 263 into which a portion of the cup may be inserted and fixed.

Accordingly, a cup holder 64 that can enhance user convenience can be formed. Meanwhile, the shape of the support hole 263 may be variously modified as needed, such as having a polygonal shape.

Meanwhile, at least a part of the inner portion and/or at least a part of the outer portion of the second box structure 60 (or the reinforcing frame 62 (shown in FIG. 4D)) may be treated with a waterproof coating to enhance water resistance. In other words, a waterproof layer having a waterproof function may be provided on at least a portion of the inner surface and/or at least a portion of the outer surface of the reinforcing frame 62.

Meanwhile, the second box structure assembling cardboard 200 shown in FIG. 4A is only an example, and a method in which the above-described plurality of plates are connected to each other may be variously changed within a range that does not impair the idea of the present invention. For example, in FIG. 4A, the second bottom surface plate 240 is configured to be connected to the lower side of the second-1 side surface plate 210, but the second bottom surface plate 240 may be configured to be connected to the lower side of the second rear surface plate 230 as needed.

In addition, in the present embodiment, the second box structure assembling cardboard 200 is made of a paper material, but may be made of a material having other properties as needed. For example, it may be made of a material such as plastic having a certain degree of rigidity and waterproofness but having some flexibility.

Hereinafter, a water purifier faucet assembly kit according to an embodiment of the present invention and a process of assembling a water purifier faucet using the assembly kit will be described.

FIG. 5A is a view illustrating a process of taking out a water purifier faucet assembly kit according to an exemplary embodiment of the present invention from an accommodation space of a base frame according to an exemplary embodiment of the present invention. FIG. 5B is an exploded perspective view of a water purifier faucet according to an exemplary embodiment of the present invention, viewed from a front upper side. In this case, an operation unit of a water outlet module is not illustrated. FIG. 5C is an exploded perspective view of a water purifier faucet according to an exemplary embodiment of the present invention, viewed from a rear upper side. In this case, an operation unit of a water outlet module is not illustrated.

Referring to FIG. 5A, the water purifier faucet assembly kit 70 according to an embodiment of the present invention is a set of components provided to assemble a water purifier faucet, as described above, and may include a base frame 300, a filter coupling module 400, a water inlet module 500 and a water outlet module 600.

Referring to FIGS. 5A to 5C, the base frame 300 may provide a base to which the filter coupling module 400, the water inlet module 500, and the water outlet module 600 are coupled. To this end, the base frame 300 may be made of a plastic material having predetermined rigidity and water resistance, but is not limited thereto.

The base frame 300 may include a frame part 310 to which the filter coupling module 400 and the water outlet module 600 are coupled, and a water inlet module cover part 320 supporting and covering the water inlet module 500.

The frame part 310 may have a box shape with one side open. In the illustrated embodiment, the frame part 310 may include a lower plate 311 that can be placed on the floor, an upper plate 312 disposed parallel above the lower plate 311, a front plate 313 vertically disposed in the front of the lower plate 311 and the upper plate 312, a rear plate 314 disposed parallel to the rear of the front plate 313, and a side plate 315 capable of covering the sides of the lower plate 311 to the rear plate 314.

Accordingly, a second accommodation space S2 may be defined inside the frame part 310 by inner surfaces of the lower plate 311 to the side plate 315 described above. One side of the second accommodation space S2, for example, a left side portion based on FIG. 5A may be open.

In this case, other components constituting the water purifier faucet assembly kit 70 may be accommodated in the second accommodation space S2 of the frame part 310. In this case, the other components may be disassembled into a plurality of parts that can be reassembled, and accommodated.

For example, referring to FIG. 5A, in the present embodiment, the water inlet module 500 and the water outlet module 600 may be respectively disassembled into three parts and accommodated in the second accommodation space S2 of the frame part 310.

As such, according to the present embodiment, since the filter coupling module 400, the water inlet module 500, and the water outlet module 600 can be compactly accommodated inside the base frame 300, portability and storage can be increased.

Of course, it is also possible that the filter coupling module 400 to be described later is configured to be also disassembled into a plurality of parts and accommodated in the second accommodation space S2 of the frame part 310. For example, it may be also configured such that an inlet part 410 and an outlet part 440 of the filter coupling module 400 protruding outward from the base frame 300 are also separated from a filter flow passage forming part 420 and accommodated together in the second accommodation space S2 of the frame part 310.

Meanwhile, referring back to FIG. 5A, an outlet part through-hole 313a through which the outlet part 440 of the filter coupling module 400 to be described below can pass may be formed in the front plate 313 of the frame part 310. The outlet part through-hole 313a may be located on the upper portion of the front plate 313 to correspond to the filter coupling module 400 disposed on the upper side portion of the base frame 300.

In the front plate 313, first and second latching protrusion holes 313b and 313c may be formed on one side, i.e., on the lower side based on FIG. 5A, of the outlet part through-hole 313a. In this case, the first and second latching protrusion holes 313b and 313c may be arranged side by side in a horizontal direction.

A fitting protrusion coupling hole 313d may be formed on one side, i.e., on the lower side based on FIG. 5A, of the first and second latching protrusion holes 313b and 313c. In this case, the fitting protrusion coupling hole 313d may have a slightly larger size than the aforementioned latching protrusion holes 313b and 313c.

Referring to FIG. 5C, an inlet part through-hole 311a through which the inlet part 410 of the filter coupling module 400 can pass may be formed in the rear plate 314. Like the outlet part through-hole, the inlet part through-hole 311a may be located on the upper portion of the rear plate 314.

Referring to FIGS. 5A to 5C together, a water inlet module cover part 320 may be provided on one side portion of the frame part 310, i.e., on the rear side of the frame part 310 in the illustrated embodiment. The water inlet module cover part 320 may include a side cover plate 322, a lower cover plate 324 and a rear cover plate 326.

The side cover plate 322 may extend rearward from an edge portion of the rear plate 314 of the frame part 310. The rear cover plate 326 bent in a horizontal direction may be provided at an end side of the side cover plate 322 in the extension direction.

A water inlet module fixing groove 326a into which a portion of the water inlet module 500 to be described later can be inserted and fixed may be formed in the rear cover plate 326. The water inlet module fixing groove 326a may be formed in the shape of a cutout groove so that a portion of the water inlet module 500 can pass through the rear cover plate 326 and be coupled thereto. In this case, the water inlet module fixing groove 326a may increase in width toward the outside, but the inner wall of the entrance side may be formed round including a curved surface.

The water inlet module 500 to be described below may be disposed between the rear plate 314 of the frame part 310 and the rear cover plate 326 of the water inlet module cover part 320. Accordingly, it is possible to minimize the effect of water leaking from the water inlet module 500 on the reinforcing frame or housing made of paper vulnerable to water.

Meanwhile, the lower cover plate 324 extending in the same direction as the extension direction of the side cover plate 322 and covering the lower portion of the water inlet module 500 may be provided at an edge portion of the lower plate 311 of the frame part 310. The lower cover plate 324 may prevent water flowing out of the water inlet module 500 from reaching the lower portion of the reinforcing frame or housing.

Referring back to FIG. 5C, in the present embodiment, the water inlet module 500 may be provided between the rear plate 314 and the rear cover plate 326 of the base frame 300. The water inlet module 500 is a component in which raw water is introduced from the outside.

In the present embodiment, the water inlet module 500 may include a first water inlet flow passage forming member 510, a pressure reducing member 520, a connection flow passage forming member 530 and a second water inlet flow passage forming member 540.

The first water inlet flow passage forming member 510 may have an outer circumferential part fitted and coupled into the water inlet module fixing groove 326a of the rear cover plate 326 described above. Accordingly, one end of the first water inlet flow passage forming member 510 may protrude and be exposed to the outside of the base frame 300. Accordingly, raw water may be introduced from the outside through the exposed end of the first water inlet flow passage forming member 510.

The pressure reducing member 520 may be provided at the other end of the first water inlet flow passage forming member 510 facing the rear plate 314 of the base frame 300. The pressure reducing member 520 may appropriately adjust the pressure of raw water introduced from the outside. The pressure reducing member 520 may include a pressure reducing valve or the like.

The second water inlet flow passage forming member 540 may be disposed on one side of the pressure reducing member 520 to form a flow passage so that raw water is supplied to the inlet part 410 of the filter coupling module 400 to be described later. To this end, the second water inlet flow passage forming member 540 may be coupled to one end of the inlet part 410.

A tubular connection flow passage forming member 530 may be provided between the second water inlet flow passage forming member 540 and the pressure reducing member 520. The connection flow passage forming member 530 may allow raw water discharged from the pressure reducing member 520 to flow into the second water inlet flow passage forming member 540.

Meanwhile, the first water inlet flow passage forming member 510, the pressure reducing member 520, the connection flow passage forming member 530 and the second water inlet flow passage forming member 540 described above may be respectively referred to as a water inlet member.

Referring back to FIGS. 5A to 5C, the base frame 300 may include a filter coupling module 400. The filter coupling module 400 is configured to allow raw water introduced through the water inlet module 500 to be filtered by the filter 40, and may include an inlet part 410, a filter flow passage forming part 420, a filter coupling part 430, and an outlet part 440.

The inlet part 410 may receive raw water from the water inlet module 500 as described above. The inlet part 410 may be coupled through the inlet part through-hole 311a of the rear plate 314 of the frame part 310.

The raw water introduced into the inlet part 410 flows into the filter flow passage forming part 420. The filter flow passage forming part 420 is a member that provides a flow passage so that raw water can pass through the filter 40, and may be provided inside the second accommodation space S2 of the frame part 310.

In the illustrated embodiment, the filter flow passage forming part 420 is coupled to the upper plate 312 of the frame part 310 and is positioned in the upper portion of the second accommodation space S2. A filter coupling part 430 may be provided on one side portion, i.e., on the lower side portion based on FIG. 5A, of the filter flow passage forming part 420.

The filter coupling part 430 is configured to provide a frame to which the filter 40 can be fixedly coupled so that the filter 40 can be connected to the inner flow passage of the filter flow passage forming part 420. A plurality of filter coupling parts 430 may be provided corresponding to the number of filters 40 used.

The filter coupling part 430 may have a shape open toward the inside of the second accommodation space S2. The filter 40 may be disposed inside the second accommodation space S2 through the open side of the second accommodation space S2 and then coupled to the filter coupling part 430 or replaced.

Purified water produced by filtering raw water in the filter 40 flows to the outlet part 440 through the filter flow passage forming part 420. The outlet part 440 is configured to provide the produced purified water to the water outlet module 600, which will be described later, and may be coupled through the outlet part through-hole 313a formed in the front plate 313 of the frame part 310. Accordingly, one end of the outlet part 440 may protrude and be exposed to the outside of the base frame 300.

Referring to FIGS. 5A to 5C, the water outlet module 600 may be provided on the outer portion of the base frame 300. The water outlet module 600 may discharge produced purified water to the outside and provide it to the user.

The water outlet module 600 may include a water outlet unit 610 that receives purified water and discharges it to the outside; a support part 620 for supporting the water outlet unit 610; and an operation unit 630 for controlling and operating the water outlet unit 610.

In the present embodiment, the water outlet unit 610 may include a water outlet unit body 612, a first water outlet flow passage forming member 614, and a second water outlet flow passage forming member 616. The first water outlet flow passage forming member 614 may be coupled to the outlet part 440 of the filter coupling module 400 to supply purified water discharged from the outlet part 440 to the water outlet unit body 612.

The water outlet unit body 612 is a member in which a flow passage is formed to receive purified water from the outside or to discharge the supplied purified water to the outside, and may be configured to selectively discharge purified water according to an external input.

In this case, first and second corresponding coupling members 618a and 618b may be formed on the side of the water outlet unit body 612 to be coupled to a support part 620 to be described later. In the illustrated embodiment, the first and second corresponding coupling members 618a and 618b are symmetrically formed on the rim of the water outlet unit body 612. In addition, the second water outlet flow passage forming member 616 for guiding a direction of purified water discharged from the water outlet unit body 612 may be coupled to the water outlet unit body 612.

In order to apply an external input to the water outlet unit body 612, the operation unit 630 may be coupled to one side portion of the water outlet unit body 612. For example, the operation unit 630 may apply an input to discharge purified water or an input to stop discharging purified water to the water outlet unit body 612 as it rotates clockwise or counterclockwise.

A support part 620 may be provided below the water outlet unit 610. The support part 620 may include a support part body 621 for supporting the water outlet unit body 612. A water outlet unit insertion hole 621a may be formed in the central portion of the support part body 621.

As a part of the water outlet unit body 612 is inserted into the water outlet unit insertion hole 621a, the water outlet unit body 612 is caught by the support part body 621, so that the support part 620 can support the water outlet unit 610.

In this case, in order to supplement the coupling force between the water outlet unit body 612 and the support part body 621, first and second water outlet unit coupling members 622a and 622b may be provided on the support part body 621.

The first and second water outlet unit coupling members 622a and 622b may be coupled to the first and second corresponding coupling members 618a and 618b of the water outlet unit 610 described above, respectively. Both configurations may be formed of various coupling structures, such as structures of coupling protrusions and coupling grooves. In this case, the first and second water outlet unit coupling members 622a and 622b may be symmetrically arranged around the water outlet unit insertion hole 621a.

First and second extension bodies 623 and 624 may be provided on one side of the support part body 621 to receive bearing capacity for supporting the water outlet unit 610 from the base frame 300.

The first extension body 623 may be formed of a member extending from the support part body 621 toward the base frame 300, and The second extension body 624 may be formed of a member extending in a direction crossing the extension direction of the first extension body 623 from an end of the extension direction of the first extension body 623.

Referring to FIGS. 5A to 5C, in the illustrated embodiment, the first extension body 623 extends in the horizontal direction, and the second extension body 624 extends in the vertical direction. In this case, first and second latching protrusions 625a and 625b and a fitting protrusion 626 that may be coupled to the base frame 300 may be provided on the second extension body 624.

The first and second latching protrusions 625a and 625b may have a shape that extends in the horizontal direction and then bends upward. In this case, the first and second latching protrusions 625a and 625b may be arranged to correspond to the first and second latching protrusion holes 313b and 313c of the front plate 313, respectively so that they are coupled through the first and second latching protrusion holes 313b and 313c, respectively.

Accordingly, when a force is applied to the support part 620 downward by the weight of the water outlet unit 610, bearing capacity may be provided as the bent ends of the first and second latching protrusions 625a and 625b are caught on the inner wall of the front plate 313.

The fitting protrusion 626 may be provided at an end side of the second extension body 624 in the extension direction. The fitting protrusion 626 may be positioned to correspond to the fitting protrusion coupling hole 313d so as to be inserted into the fitting protrusion coupling hole 313d of the front plate 313. The fitting protrusion 626 may be coupled to the front plate 313 to supplement the bearing capacity for supporting the water outlet unit 610, while the support part 620 can be balanced and fixed in position.

According to the above-described coupling relationship, the water purifier faucet 72 can be assembled using the water purifier faucet assembly kit 70 according to an embodiment of the present invention. As such, the water purifier faucet assembly kit 70 according to the present embodiment can be easily assembled and disassembled without special knowledge or tools, and thus, can be easily maintained and repaired by users, and can increase portability and usability in various places.

In this case, if the water purifier faucet 72 according to an embodiment of the present invention can receive raw water from the outside, it can perform the basic function of a water purifier that provides purified water by filtering the raw water, and for this purpose, a separate power supply is not required.

Therefore, according to the present embodiment, users can receive purified water even in situations where power is not available, such as outdoor spaces such as camping grounds, places where social infrastructure is not sufficiently prepared, such as in developing countries, and emergency situations such as power outages.

Meanwhile, the above-described water outlet unit 610, support part 620, and operation unit 630 may be referred to as a water outlet member, a support member, and an operation member, respectively.

Hereinafter, a process of assembling a water purifier according to an embodiment of the present invention will be described in more detail.

FIG. 6 is a view for explaining a process of forming an intermediate assembly by coupling a water purifier faucet and a reinforcing frame according to an exemplary embodiment of the present invention. FIGS. 7A and 7B are views for explaining a process of reassembling a first box structure according to an exemplary embodiment of the present invention into a housing and forming a water purifier body by coupling the reassembled housing and the intermediate assembly. FIG. 8A is a view illustrating a process of forming a water purifier by coupling a water purifier body, a support plate, and a cup holder according to an exemplary embodiment of the present invention. FIG. 8B is a perspective view of a water purifier according to an exemplary embodiment of the present invention, viewed from an upper side.

Referring to FIG. 5C and FIG. 6, according to an embodiment of the present invention, an intermediate assembly 62, 72 may be formed by coupling the water purifier faucet 72 with the reinforcing frame 62. Accordingly, the lower side portion of the base frame 300 may be supported by the second bottom surface plate 240 of the reinforcing frame 62.

In this case, an end of the first water inlet flow passage forming member 510 of the water purifier faucet 72 may be coupled through the second-1 to second-3 water inlet module through-holes 231, 233, and 245. Accordingly, an end of the first water inlet flow passage forming member 510 may be exposed to the outside of the reinforcing frame 62, and thus, raw water may be supplied from the outside.

Meanwhile, as the water purifier faucet 72 is coupled to the inside of the reinforcing frame 62, the water outlet unit 610 and the support part 620 of the water outlet module 600 protruding forward from the base frame 300 may protrude out of the reinforcing frame 62 through upper portions of the second lower front surface plate 220a and the second lower front surface cover plate 222a.

In this case, the second lower front surface plate 220a and the second lower front surface cover plate 222a of the reinforcing frame 62 may have a restoring force to return to a shape closer to the original shape. In other words, the second lower front surface plate 220a and the second lower front surface cover plate 222a overlapping each other have a property of returning to a position where they cross each other at a predetermined angle as the bent parts are unfolded, and accordingly, push the water purifier faucet 72 from the front to the rear.

Similarly, the second rear surface plate 230 and the second rear surface cover plate 232 of the reinforcing frame 62 also have a predetermined restoring force, and thus push the water purifier faucet 72 from the rear to the front. Accordingly, the water purifier faucet 72 can be stably fixed in position inside the reinforcing frame 62.

Referring to FIG. 7A, As the intermediate assembly 62, 72 is accommodated in the first accommodation space S1 inside the housing 52, a water purifier body 52, 62, 72 may be formed. In this case, the housing 52 may be formed by reassembling the first box structure 50 (shown in FIG. 3C).

The housing 52 may have the above-described first accommodation space S1 to accommodate the intermediate assembly 62, 72, and include an accommodation part 110, 120, 130, 140, 150 with one side portion opened; a water outlet unit 610 protruding forward of the intermediate assembly 62, 72; a water outlet unit cover part 170 for covering the support part 620; and a cover part 160 for opening and closing the opening of the accommodation part 110, 120, 130, 140, 150.

In the present embodiment, the accommodation part 110, 120, 130, 140, 150 may include a first-1 side surface plate 110, a first rear surface plate 120, a first-2 side surface plate 130, a first bottom surface plate 140, and a first front surface plate 150. As described in conjunction with FIGS. 3A to 3C, the first-1 side surface plate 110 and the first-2 side surface plate 130 may form opposite side surfaces of the accommodation part 110, 120, 130, 140, 150; the first rear surface plate 120 may form the rear surface of the accommodation part 110, 120, 130, 140, 150; the first front surface plate 150 may form the front surface of the accommodation part 110, 120, 130, 140, 150; and the first bottom surface plate 140 may form the bottom surface of the accommodation part 110, 120, 130, 140, 150.

In this case, as described above, an opening may be formed in the accommodation part. Through the opening of the accommodation part, the intermediate assembly 62, 72 may enter and exit the first accommodation space S1, or the filter 40 (shown in FIG. 6) may enter and exit the second accommodation space S2 of the base frame 300 (shown in FIG. 6).

To this end, one part of the opening of the accommodation part 110, 120, 130, 140, 150 may be opened in one direction, and the other part may be opened in a different direction from the one direction to form a filter entrance and exit part 131. In this case, as described above, the filter entrance and exit part 131 may be opened in the same direction as the direction in which the second accommodation space S2 (shown in FIG. 6) of the base frame 300 (shown in FIG. 6) is opened.

In the illustrated embodiment, one part of the opening of the accommodation part 110, 120, 130, 140, 150 may form an open top surface, and the other part of the opening of the accommodation part 110, 120, 130, 140, 150 may form a filter entrance and exit part 131 provided on the first-2 side surface plate 130.

As described above, the cover part 160 may include a first-2 top surface cover plate 162 of a flat plate shape capable of opening and closing the open top surface of the accommodation part 110, 120, 130, 140, 150; and a first side surface cover plate 164 of a flat plate shape capable of opening and closing the filter entrance and exit part 131 of the accommodation part 110, 120, 130, 140, 150. In this case, as described above, the first-2 top surface cover plate 162 and the first side surface cover plate 164 may be foldably connected to each other.

The intermediate assembly 62, 72 may be inserted into the first accommodation space S1 as it moves downward, in a state in which the upper portion of the first accommodation space S1 is opened by the first-1 and first-2 top surface cover plates 124 and 162.

When the intermediate assembly 62, 72 is accommodated in the first accommodation space S1, an end of the first water inlet flow passage forming member 510 (shown in FIG. 5C) of the water purifier faucet 72 may be coupled through the first water inlet module through-hole 121. Accordingly, an end of the first water inlet flow passage forming member 510 (shown in FIG. 5C) may be exposed to the outside of the housing 52, and thus, raw water may be supplied from the outside.

In this case, as described above, since the first water inlet module through-hole 121 is formed in a direction parallel to the moving direction of the intermediate assembly 62, 72, an end of the first water inlet flow passage forming member 510 (shown in FIG. 5C) may be inserted into the first water inlet module through-hole 121, and thus, users can easily combine both components.

Meanwhile, referring to FIGS. 6 and 7A together, since the second upper front surface plate 220b and the second upper front surface cover plate 222b bent outward of the second-1 side surface plate 210 have restoring force to be restored to an unbent state, the second upper front surface plate 220b and the second upper front surface cover plate 222b may push the first-1 side surface plate 110 of the housing 52.

As a counteraction, the intermediate assembly 62, 72 may receive a predetermined force from the first-1 side surface plate 110 toward the first-2 side surface plate 130. Similarly, the intermediate assembly 62, 72 may receive a predetermined force from the first rear surface plate 120 and the first front surface plate 150.

Accordingly, the intermediate assembly 62, 72 may be coupled with a fitting feeling inside the first accommodation space S1 of the housing 52, compensate for the tolerance, and also be stably supported and fixed.

In this case, when the intermediate assembly 62, 72 is disposed in the first accommodation space S1, the open side of the base frame 300 may be open to the outside through the filter entrance and exit part 131. Accordingly, users may move the first side surface cover plate 164 to open the side of the first accommodation space S1 through the filter entrance and exit part 131, and thus, easily replace the filter inside the water purifier faucet 72.

In addition, according to the present embodiment, by moving the first-1 and first-2 top surface cover plates 124 and 162 to open the upper portion of the first accommodation space S1, users can easily maintain and repair the water purifier faucet 72 and the reinforcing frame 62 without additional knowledge or tools.

Meanwhile, when the intermediate assembly 62, 72 is disposed in the first accommodation space S1, the water outlet unit 610 and the support part 620 of the water outlet module may protrude outward from the first accommodation space S1 through the upper portion of the first front surface plate 150 of the housing 52.

In this case, in order to protect the water outlet unit 610 and the support part 620 protruding outside the first accommodation space S1 from the outside, it may be reassembled in a form in which the water outlet unit cover part 170 of the housing 52 covers the water outlet unit 610 and the support part 620.

More specifically, referring to FIGS. 5B and 7A together, the lower side portion of the water outlet unit 610 may be covered by the water outlet unit bottom surface plate 171. The relative positions of the water outlet unit 610 and the water outlet unit bottom surface plate 171 may be adjusted so that purified water discharged from the second water outlet flow passage forming member 616 of the water outlet unit 610 comes out of the housing 52 through the water outlet hole 171a.

The water outlet unit front surface plate 174 may be bent upwardly perpendicular to the water outlet unit bottom surface plate 171 so as to cover the front portion of the water outlet unit 610 and the support part 620. In this case, by the first water outlet unit front surface folding line F174a (shown in FIG. 3A) and the second water outlet unit front surface folding line F174b, the water outlet unit bottom surface plate 171 and the water outlet unit front surface plate 174 may be naturally offset and bent.

The water outlet unit top surface plate 175 may be bent in a horizontal direction perpendicular to the water outlet unit front surface plate 174 so as to cover the upper side portion of the water outlet unit 610 and the support part 620. In this case, a position between the water outlet unit 610 and the water outlet unit top surface plate 175 may be adjusted so that the upper portion of the water outlet unit body 612 can be exposed to the outside through the operation unit through-hole 175a.

The first and second water outlet unit side surface plates 176 and 178 may be bent to cover both sides of the water outlet unit 610 and the support part 620. Accordingly, the housing 52 according to an embodiment of the present invention may cover and protect the water outlet unit 610 and the support part 620 protruding outward from the first accommodation space S1.

Meanwhile, according to an embodiment of the present invention, since the reinforcing frame 62 and the housing 52 are made of paper, they can be easily decomposed in nature even if discarded after assembly or use, thereby preventing environmental contamination due to waste.

Referring to FIG. 7B, through the operation unit through-hole 175a provided on the water outlet unit top surface plate 175 of the water outlet unit cover part 170, an end of the operation unit 630 of the water outlet module 600 may be coupled to the water outlet unit body 612 of the water outlet unit 610. Accordingly, users may operate the operation unit 630 to selectively apply an input to discharge purified water or an input to stop discharging purified water to the water outlet unit 610.

Referring to FIGS. 8A and 8B, in an embodiment of the present invention, the upper packaging buffer member 20 may be used as a support plate for supporting the water purifier body 52, 62, 72.

The lower side portion of the water purifier body 52, 62, 72 may be fitted into the water purifier body fixing part 21a of the upper fixing groove 21, and thus, may be fixed in position and supported by the support plate. In this case, a cup holder 64 formed by reassembling a part of the second box structure 60 (shown in FIG. 4B) may be fitted and coupled into the cup holder fixing part 21b of the upper fixing groove 21, and thus, a support hole 263 capable of fixing a cup may be provided to a user.

Accordingly, the water purifier box package according to an embodiment of the present invention can minimize wasted waste, thereby minimizing environmental pollution and waste of resources due to waste generation, and increasing user convenience.

As such, the water purifier box package 1 according to an embodiment of the present invention can be easily assembled and used by a user without specialized knowledge or special tools, and then re-disassembled and returned to the box-shaped package 1.

Accordingly, since the water purifier box package 1 according to the present embodiment can be assembled and used as a water purifier in various places desired by a user, and can be stored and carried in the form of a box-shaped package 1 as needed, it is possible to secure the possibility of using the water purifier without limiting the location, and increase the ease of storage and portability of the water purifier.

In addition, as most of the components constituting the water purifier box package 1 according to the present embodiment are reassembled as one component, waste can be minimized, and thus environmental pollution and resource waste can be prevented.

Furthermore, since most of the water purifier box package 1 according to the present embodiment are made of a paper material that is easily decomposed in nature, environmental pollution due to waste can be prevented even if discarded after use.

Hereinafter, a water purifier according to a modification example of an embodiment of the present invention will be described.

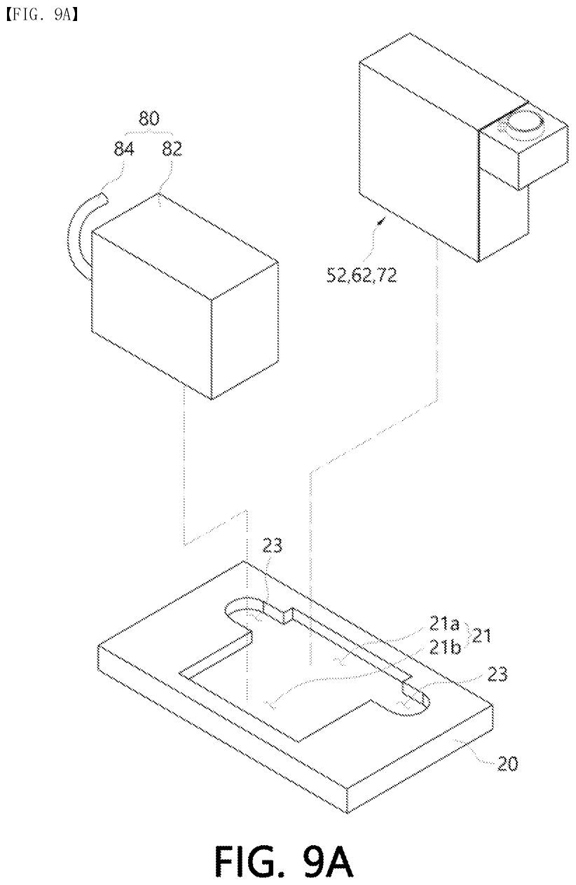

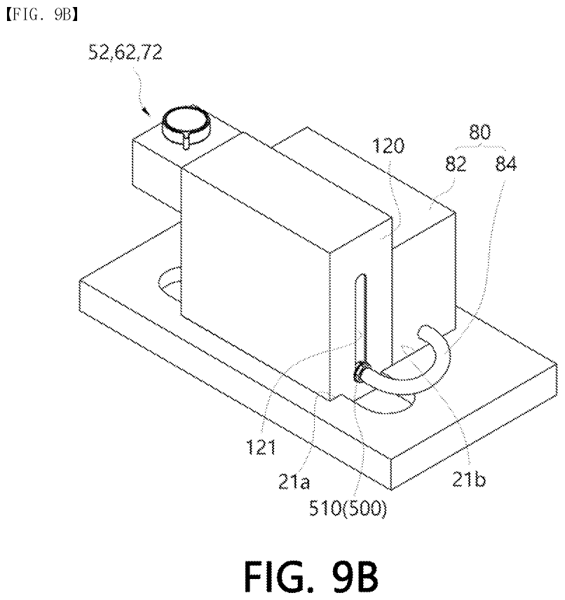

FIG. 9A is a view illustrating a process of forming a modification example of a water purifier according to an exemplary embodiment of the present invention. FIG. 9B is a perspective view of a modification example of a water purifier according to an exemplary embodiment of the present invention, viewed from an upper side. In this case, configurations indicated by the same reference numerals may be identical to the configurations described above.

Referring to FIGS. 9A and 9B, the water purifier according to the present modification example may include a water purifier body 52, 62, 72, an upper packaging buffer member 20, and a raw water supply unit 80. In this case, as described above, since the water purifier body 52, 62, 72 and the upper packaging buffer member 20 may have the same configuration as in an embodiment of the present invention, the description of the configuration of the same will be replaced with the previous description.

The raw water supply unit 80 may include a raw water tank 82 in which raw water can be stored; and a raw water supply pipe 84 provided at one side of the raw water tank 82 to form a flow passage for supplying raw water to the water purifier body 52, 62, 72.

In this case, a lower side portion of the raw water tank 82 may be configured to be inserted and fixed to the cup holder fixing part 21b of the upper fixing groove 21. Of course, the raw water tank 82 may be configured to be separately disposed outside the upper packaging buffer member 20.

An end of the raw water supply pipe 84 may be fluidly communicatively connected to the first water inlet flow passage forming member 510 of the water purifier body 52, 62, 72. In this case, it may be exposed to the outside through the first water inlet module through-hole 121 formed in the first rear surface plate 120 of the water purifier body 52, 62, 72.

Accordingly, the raw water stored in the raw water tank 82 may be supplied to the inside of the water purifier body 52, 62, 72 through the raw water supply pipe 84 at a predetermined pressure.

According to the present modification example, even in situations where there is no immediate source of raw water available near the water purifier, the raw water tank 82 can be filled with raw water and then fluidly communicatively connected to the water purifier body 52, 62, 72 to filter the raw water to produce purified water.

As such, the water purifier according to the present modification example includes a separate raw water supply unit 80, and thus, can provide purified water regardless of the place and situation, such as a place where facilities for supplying raw water are not prepared or a place far from the water source.

Meanwhile, in another embodiment, it can be configured that at least one of the components of the water purifier box package according to an embodiment of the present invention described above is not included. For example, the outer packaging box structure 10 (shown in FIG. 1) may not be included as needed.

Hereinafter, a method for assembling a water purifier according to an embodiment of the present invention will be described. For convenience of description, a method for assembling the water purifier faucet assembly kit and the water purifier box package according to an embodiment of the present invention described above will be described. However, the method for assembling a water purifier according to an embodiment of the present invention is not limited thereto, and the method for assembling a water purifier according to an embodiment of the present invention may be applied to various water purifier box packages in which a water purifier faucet assembly kit is packaged.

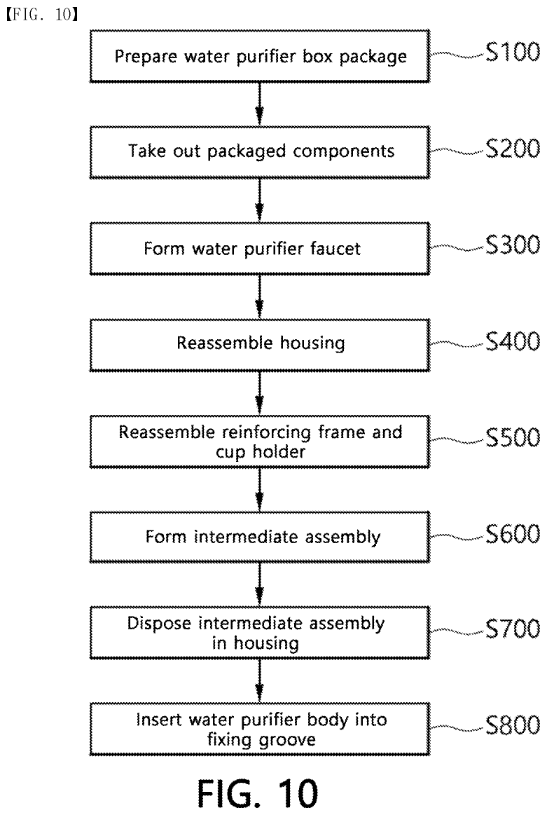

FIG. 10 is a flowchart for explaining a method for assembling a water purifier according to an exemplary embodiment of the present invention.

Referring to FIG. 10 together with FIGS. 1 to 4B, in the method for assembling a water purifier according to an embodiment of the present invention, a water purifier box package 1 is prepared at step S100. In this case, as described above, the water purifier box package 1 is for packaging the water purifier faucet assembly kit 70, and may include an outer packaging box structure 10, an upper packaging buffer member 20, a lower packaging buffer member 30, a first box structure 50, and a second box structure 60.

Inside the second box structure 60, the water purifier faucet assembly kit 70 may be accommodated and packaged. Inside the first box structure 50, the second box structure 60 may be accommodated and packaged. The upper and lower portions of the first box structure 50 may be covered and protected by the upper packaging buffer member 20 and the lower packaging buffer member 30. The outer portions of the upper packaging buffer member 20 and the lower packaging buffer member 30 may be accommodated and packaged inside the outer packaging box structure 10.

Again, referring to FIG. 10 together with FIGS. 4B to 5C, in the method for assembling a water purifier according to an embodiment of the present invention, a water purifier box package 1 is prepared at step S100, components packed inside are taken out of the water purifier box package 1 at step S200, and a water purifier faucet 72 is formed at step S300.

In this case, the components packed inside may be a water purifier faucet assembly kit 70. The water purifier faucet assembly kit 70 may include a base frame 300, a filter coupling module 400, a water inlet module 500, and a water outlet module 600, which are separated from each other. A water purifier faucet 72 may be formed by assembling the above components. In this case, a method for assembling the water purifier faucet assembly kit 70 to form the faucet water purifier 72 may be performed as described above with reference to FIGS. 5A to 5C.

Referring back to FIG. 10 together with FIGS. 3A to 4D, in the method for assembling a water purifier according to an embodiment of the present invention, a housing 52 is formed by reassembling the first box structure 50 at step S400, and a reinforcing frame 62 and a cup holder 62 are formed by reassembling the second box structure 60 at step S500. In this case, the method of forming the housing 52 by reassembling the first box structure 50 and the method of forming the reinforcing frame 62 and the cup holder 62 by reassembling the second box structure 60 may be performed as described above with reference to FIGS. 3A to 4D.

Referring to FIG. 10 together with FIG. 6, in the method for assembling a water purifier according to an embodiment of the present invention, an intermediate assembly 62, 72 is formed by assembling the water purifier faucet 72 and the reinforcing frame 62 at step S600. In this case, the method of forming the intermediate assembly 62, 72 may be performed as described above with reference to FIG. 6.

Referring to FIG. 10 together with FIGS. 7A and 7B, in the method for assembling a water purifier according to an embodiment of the present invention, after the intermediate assembly 62, 72 is formed at step S600, the intermediate assembly 62, 72 is disposed in the first accommodation space S1 of the housing 52 to form a water purifier body 52, 62, 72 at step S700. In this case, the method of forming the water purifier body 52, 62, 72 may be performed as described above with reference to FIGS. 7A and 7B.

Referring to FIG. 10 together with FIGS. 8A and 8B, in the method for assembling a water purifier according to an embodiment of the present invention, after the water purifier body 52, 62, 72 is formed at step S700, the water purifier body 52, 62, 72 is inserted and fixed into the upper fixing groove 21 of the upper packaging buffer member 20 at step S800. In this case, the method of inserting and fixing the water purifier body 52, 62, 72 into the upper fixing groove 21 may be performed as described above with reference to FIGS. 8A and 8B.

Meanwhile, according to the method for assembling a water purifier according to an embodiment of the present invention, the assembled water purifier body 52, 62, 72 and the upper packaging buffer member 20 may be restored to the water purifier box package 1, in which the water purifier faucet assembly kit 70 is packaged, by performing the reverse order of the above-described method.

As such, according to the method for assembling a water purifier according to an embodiment of the present invention, since it can be easily assembled and restored without special knowledge or tools, the portability of the water purifier can be increased, there is no limit on usability according to space or circumstances, and environmental pollution or waste of resources due to waste can be prevented.

Although exemplary embodiments of the present invention have been described above, the idea of the present invention is not limited to the embodiments set forth herein. Those of ordinary skill in the art who understand the idea of the present invention may easily propose other embodiments through supplement, change, removal, addition, etc. of elements within the scope of the same idea, but the embodiments will be also within the idea scope of the present invention.

### DESCRIPTION OF SYMBOLS

| | |
|---|---|
| 1: water purifier box package | 2: water purifier |
| 10: outer packaging box structure | 20: upper packaging buffer |
| | member |
| 30: lower packaging buffer | 40: filter |
| member | |
| 50: first box structure | 52: housing |
| 60: second box structure | 62: reinforcing frame |
| 64: cup holder | 70: water purifier faucet assembly kit |
| 72: water purifier faucet | 80: raw water supply unit |
| 100: first box structure assembling | 200: second box structure assembling |
| cardboard | cardboard |
| 300: base frame | 400: filter coupling module |
| 500: water inlet module | 600: water outlet module |

What is claimed is:

1. A water purifier, comprising:
a housing having a first accommodation space therein, and made of a paper material;
a water purifier faucet disposed in the first accommodation space to receive raw water from the outside and discharge purified water to the outside; and
a filter coupled to the water purifier faucet to generate the purified water by filtering the raw water,
wherein the water purifier faucet comprises:
a base frame having a second accommodation space therein in which the filter is accommodated;
a water inlet module provided on one side of the base frame to supply raw water introduced from the outside to the filter; and
a water outlet module provided on the other side of the base frame to receive the purified water generated by the filter and discharge it to the outside.

2. The water purifier of claim 1, wherein in a packaged state in which the filter, the base frame, the water inlet module, and the water outlet module are packaged, the housing is provided to be formed by reassembling a first box structure provided to package at least one of the filter, the base frame, the water inlet module, and the water outlet module.

3. The water purifier of claim 1,
wherein the housing comprises an accommodation part with one side portion of which is opened so that the first accommodation space can communicate with the outside, and
wherein the base frame has one side portion open so that the filter can enter and exit the second accommodation space through the opening of the accommodation part.

4. The water purifier of claim 3, wherein one part of the opening of the accommodation part is open in one direction so that the water purifier faucet can enter and exit the first accommodation space.

5. The water purifier of claim 3,
wherein the housing comprises a flat plate-shaped cover part provided on one side of the accommodation part to close the opening of the accommodation part in a closed position and open the opening of the accommodation part to the outside in an open position,
wherein the other side portion of the cover part is connected to the accommodation part so that the one side portion can be rotated with respect to the accommodation part.

6. The water purifier of claim 5,
wherein in a packaged state in which the filter, the base frame, the water inlet module, and the water outlet module are packaged, the housing is provided to be formed by reassembling a first box structure provided to package at least one of the filter, the base frame, the water inlet module, and the water outlet module,
wherein the first box structure is provided to be formed by assembling a first box structure assembling cardboard,
wherein the first box structure assembling cardboard comprises:
a plurality of flat plates that are foldably connected to form one side surface of the accommodation part, the other side surface opposite to the one side surface and provided with the other part of the opening of the accommodation part, a front surface, a rear surface, and a bottom surface;
a top surface cover plate that is foldably connected to any one of the plurality of plates to open and close the one part of the opening of the accommodation part provided between the one side surface and the other side surface of the accommodation part; and
a side surface cover plate that is foldably connected to one side of the top surface cover plate to open and close the other part of the opening of the accommodation part.

7. The water purifier of claim 1,
wherein the water outlet module comprises:
a water outlet unit protruding outward from the base frame and having a water outlet hole for discharging purified water on one side portion; and
an operation unit provided on the other side portion of the water outlet unit to operate the water outlet unit, and
wherein the housing comprises:
an accommodation part for accommodating the base frame; and
a water outlet unit cover part provided at one side of the accommodation part to cover the water outlet unit of the water outlet module, and having a water outlet hole for exposing the water outlet hole to the outside and an operation unit through-hole through which the operation unit passes.

8. The water purifier of claim 7,
wherein the water outlet unit protrudes forward of the base frame,
wherein in a packaged state in which the filter, the base frame, the water inlet module, and the water outlet module are packaged, the housing is provided to be formed by reassembling a first box structure provided to package at least one of the filter, the base frame, the water inlet module, and the water outlet module,
wherein the first box structure is provided to be formed by assembling a first box structure assembling cardboard,
wherein the first box structure assembling cardboard comprises:
a plurality of flat plates that are foldably connected to form one side surface of the accommodation part, the other side surface opposite to the one side surface, and a bottom surface;
a first rear surface plate that is foldably connected to one of the plurality of flat plates to form a rear surface of the accommodation part;
a first front surface plate that is foldably connected to one of the plurality of flat plates to form a front surface of the accommodation part;
a water outlet unit bottom surface plate that is foldably connected to one side of the first front surface plate to cover a lower portion of the water outlet unit, and having the water outlet hole;
a water outlet unit front surface plate that is foldably connected to one side portion of the water outlet unit bottom surface plate to cover a front portion of the water outlet unit; and
a water outlet unit top surface plate that is foldably connected to one side portion of the water outlet unit front surface plate to cover an upper portion of the water outlet unit, and having the operation unit through-hole.

9. The water purifier of claim 8, wherein the first front surface plate has a vertical length shorter than that of the first rear surface plate.

10. The water purifier of claim 1,
further comprising a reinforcing frame made of paper and interposed between a portion of an inner surface of the housing and a portion of an outer surface of the water purifier faucet so that the water purifier faucet can be fixed to the first accommodation space,
wherein the reinforcing frame comprises:
a reinforcing part covering a portion of an outer surface of the water purifier faucet;
a bent part bent from one side portion of the reinforcing part toward the outside of the reinforcing part; and
an extension part extending from the bent part, one surface of which is disposed to face an outer surface of the reinforcing part.

11. The water purifier of claim 10,
wherein in a packaged state in which the filter, the base frame, the water inlet module, and the water outlet module are packaged, the housing is provided to be formed by reassembling a first box structure provided to package at least one of the filter, the base frame, the water inlet module, and the water outlet module,
wherein in the packaged state, the reinforcing frame is provided to be formed by reassembling a second box structure provided to package at least one of the filter, the base frame, the water inlet module, and the water outlet module,
wherein the second box structure is provided to be formed by assembling a second box structure assembling cardboard,
wherein the second box structure assembling cardboard comprises:
a plurality of flat plates that are foldably connected to form one side surface, a rear surface, and a bottom surface of the reinforcing part; and
a second front surface plate formed to be foldable on one of the plurality of flat plates and having a cutting line in a horizontal direction so that the second front surface plate can be separated into a second lower front surface plate capable of forming the front surface of the reinforcing part and a second upper front surface plate capable of forming the extension part.

12. The water purifier of claim 1,
further comprising a support plate having a plate shape and having a fixing groove formed on one surface so that one side portion of the housing can be inserted and fixed,
wherein in a packaged state in which the filter, the base frame, the water inlet module, and the water outlet module are packaged, the housing is provided to be formed by reassembling a first box structure provided to package at least one of the filter, the base frame, the water inlet module, and the water outlet module,
wherein the support plate is a packaging buffer member for packaging into which one side portion of the first box structure can be inserted into the fixing groove so that the support plate can cover one side portion of the first box structure in the packed state to protect the first box structure from external impact.

13. The water purifier of claim 12,
further comprising a cup holder having a support hole into which a cup can be inserted and supported,
wherein the one side portion of the housing is inserted into a part of the fixing groove,
wherein the cup holder is inserted into the other part of the fixing groove and provided to be formed by reassembling a part of a second box structure accommodated in the first box structure in the packaged state,
wherein the second box structure is provided to package at least one of the filter, the base frame, the water inlet module and the water outlet module.

14. The water purifier of claim 1,
wherein the water purifier faucet is formed by assembling a water purifier faucet assembly kit, the water purifier faucet assembly kit comprising:
a plurality of water inlet flow passage forming members that can be coupled to each other;
a pressure reducing member that can be provided between the water inlet flow passage forming members;
a water outlet member forming a flow passage through which the purified water is discharged to the outside;
an operation member coupled to one side portion of the water outlet member to operate the water outlet member; and
the base frame for supporting the plurality of water inlet flow passage forming members and the water outlet member.

15. The water purifier of claim 14, wherein the second accommodation space of the base frame is configured to accommodate the plurality of water inlet flow passage forming members, the pressure reducing member, the water outlet member and the operation member.

16. A method for assembling a water purifier, comprising:
preparing a water purifier box package in which a water purifier filter, a water purifier base frame, a water purifier water inlet module, and a water purifier water outlet module are packaged therein, the water purifier box package comprising a first box structure in which at least one of the filter, the base frame, the water inlet module, and the water outlet module is packaged;
taking out the filter, the base frame, the water inlet module, and the water outlet module from the water purifier box package;
forming a water purifier faucet by assembling the filter, the base frame, the water inlet module, and the water outlet module;
forming a housing having a first accommodation space therein by reassembling the first box structure; and
forming a water purifier body by disposing the water purifier faucet in the first accommodation space.

17. The method for assembling a water purifier of claim 16,
wherein the water purifier box package comprises a second box structure in which at least one of the water inlet module and the water outlet module is packaged,
the method further comprising:
forming a reinforcing frame interposed between a portion of an outer surface of the water purifier faucet and a portion of an inner surface of the housing by reassembling at least a portion of the second box structure; and
forming an intermediate assembly by assembling the reinforcing frame and the water purifier faucet such that the reinforcing frame covers the portion of an outer surface of the water purifier faucet,
wherein in the forming the water purifier body, the intermediate assembly is disposed in the first accommodation space.

18. The method for assembling a water purifier of claim 16,
wherein the water purifier box package comprises a second box structure in which at least one of the water inlet module and the water outlet module is packaged,
the method further comprising:
forming a cup holder having a support hole into which a cup can be inserted by reassembling at least a portion of the second box structure; and
disposing the cup holder on one side of the water purifier body.

19. The method for assembling a water purifier of claim 16,
wherein the water purifier box package further comprises a packaging buffer member having a fixing groove into which the one side portion of the first box structure is inserted and fixed so that the first box structure can be protected from external impact,
the method further comprising inserting and fixing one side portion of the water purifier body into the fixing groove.

20. The method for assembling a water purifier of claim 16, wherein the first box structure is made of a paper material.
